(19) United States
(12) Patent Application Publication
(10) Pub. No.: US 2026/0365806 A1
(43) Pub. Date: Nov. 19, 2026

(54) Method for Preparing Fiber-Reinforced Parts

(71) Applicant: ARXADA AG, Visp (CH)

(72) Inventors: Jean Fournier, Visp (CH); Magnus Abgottspon, Visp (CH); Gaetano La Delfa, Visp (CH); Flavio Kieliger, Visp (CH); Stefan Ellinger, Visp (CH)

(21) Appl. No.: 19/487,649

(22) PCT Filed: May 28, 2024
(86) PCT No.: PCT/EP2024/064580

§ 371 Date: Nov. 25, 2025

(30) Foreign Application Priority Data
Jun. 2, 2023 (EP) 23176942.3

(51) Int. Cl. C08J 5/24; B29C 70/48; B29K 23/00; B29K 307/04; B29L 23/00; C08L 65/00

(52) U.S. Cl. CPC C08J 5/243; B29C 70/48; C08J 5/244; C08L 65/00; B29K 2023/38; B29K 2307/04; B29K 2909/08; B29L 2023/22; C08J 2365/00; C08J 2409/06; C08J 2463/02; C08J 2463/04; C08J 2479/08

(57) ABSTRACT

The present invention relates to a method for preparing fiber-reinforced parts based on cyclopentadiene resins and blends thereof, to fiber-reinforced parts obtainable by said method, to the use of said fiber-reinforced parts in visible or non-visible applications, to visible or non-visible applications comprising said fiber-reinforced parts, and to kits, which are suitable for the method for preparing said fiber-reinforced parts.

### TECHNICAL FIELD

The present invention relates to a method for preparing fiber-reinforced parts based on cyclopentadiene resins and blends thereof, to fiber-reinforced parts obtainable by said method, to the use of said fiber-reinforced parts in visible or non-visible applications, to visible or non-visible applications comprising said fiber-reinforced parts, and to kits, which are suitable for the method for preparing said fiber-reinforced parts.

### TECHNOLOGICAL BACKGROUND

There are several established methods for the production of fiber-reinforced parts based on thermoset resins. More current methods, such as resin infusion, resin injection, filament winding, pultrusion and compression molding and further variants hereof can be technically and economically more efficient than the traditional prepregging (see e.g. Flake C. Campbell, Jr., Manufacturing Processes for Advanced Composites, Elsevier Ltd. 2004, ISBN 978-1-85617-415-2). These methods allow the utilization of carbon fiber reinforced plastic (CFRP) molds for the manufacturing of high performance composite materials. For small part production volumes, CFRP molds are much cheaper than steel or invar tooling. Invar tooling is usually required to provide beneficial thermal expansion to manufacture dimensionally stable materials. CFRP molds offer a thermal expansion coefficient similar to that of the parts manufactured using these molds, which eventually leads to better dimensional accuracy (see Campbell, pp. 104-110, 336).

Today, those materials generally are manufactured with prepreg materials (material that has been pre-impregnated), mainly based on carbon and/or glass fiber reinforced epoxy resin systems. However, it is getting more and more common to utilize liquid resin systems for manufacturing CFRP by infusion. Due to the lower thermal stability of e.g. epoxy resins and their poor electronic properties (Dk/Df) their application is limited.

With regard to the manufacturing of fiber-reinforced parts, suitable resins are desired, which provide well-balanced properties with regard to workability, electronic properties (such as low dielectric constant and low dielectric loss), thermal properties (such as high glass transition temperature and/or low thermal shrinkage), and mechanic properties (such as tensile strength).

Even though hydrocarbon resins having a high glass transition temperature are known from e.g. WO 2021/252728, suitable fiber-reinforced parts and method of preparing the same are still needed.

Against this background, there is a need for improved methods of preparing fiber-reinforced parts, as well as for fiber-reinforced parts having well-balanced properties with regard to workability, electronic properties, thermal properties, and mechanical properties.

It is thus an object of the invention to provide fiber-reinforced parts, such as CFRP, having well-balanced properties, e.g. that withstand high thermal stress (e.g. having a high glass transition temperature (Tg)) and/or show excellent electronic properties. It is a further object of the present invention to provide a method, preferably a time-efficient method, for producing fiber-reinforced parts having well-balanced properties, e.g. that withstand high thermal stress and/or show excellent electronic properties. In this connection, it is an object of the present invention to provide a straightforward method (e.g. providing starting material having improved workability such as having low viscosity) and/or a method having improved flexibility (e.g. high compatibility) and/or stability (e.g. with regards to the applied resin composition) for producing said fiber-reinforced parts.

### SUMMARY OF THE INVENTION

In a first aspect, the present invention relates to a method for preparing a fiber-reinforced part comprising the steps of
(i) providing a resin composition (RC) comprising
a) a hydrocarbon resin composition (HRC) derived from a hydrocarbon resin having a structure as defined by formula (A3)

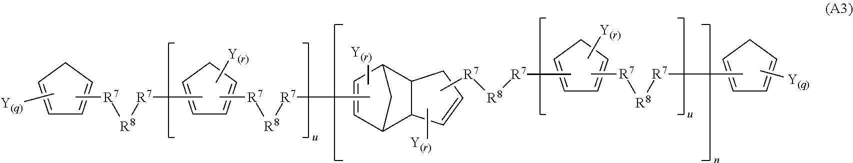

wherein
R⁷ is independently a methylene group (CH₂) or a methylene group substituted with one or more —CH₃ or halogen functionalities;
R⁸ is independently a bond or a straight-chain or branched, linear or cyclic, saturated or unsaturated, substituted or unsubstituted, aliphatic or aromatic group having between 1 and 20 carbon atoms,
Y is independently a functionality possessing at least one non-aromatic alkene, alkyne, C1-C13-alkyl, or an aromatic moiety;
q is an integer of 1 to 5;
r is independently 0 or an integer of 1 to 4,
u is independently 0, or an integer greater than or equal to 1, when u is 0, the bracket region represents a bond, and
n is 0 or an integer greater than or equal to 1, when n is 0, the bracket region represents a bond;
b) optionally at least one di- or polyfunctional resin (B); and
c) a catalyst (C);
(ii) providing a fiber structure;
(iii) contacting said fiber structure with said resin composition (RC) providing a fiber composition (FC); and
(iv) curing said fiber composition (FC).

According to a second aspect, the present invention relates to a fiber-reinforced part obtainable by a method according to the first aspect.

According to a third aspect, the present invention relates to the use of the fiber-reinforced part according to the second aspect in visible or non-visible applications.

According to a fourth aspect, the present invention relates to a visible or non-visible application comprising the fiber-reinforced part according to the second aspect.

According to a fifth aspect, the present invention relates to a kit comprising
1) a container (A) comprising
a resin composition (RC) comprising
a) a hydrocarbon resin composition (HRC) derived from a hydrocarbon resin having a structure as defined by formula (A3)

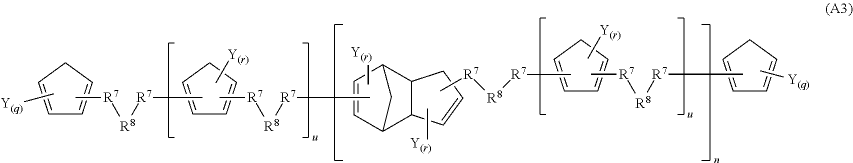

wherein
R⁷ is independently a methylene group (CH₂) or a methylene group substituted with one or more —CH₃ or halogen functionalities;
R⁸ is independently a bond or a straight-chain or branched, linear or cyclic, saturated or unsaturated, substituted or unsubstituted, aliphatic or aromatic group having between 1 and 20 carbon atoms,
Y is independently a functionality possessing at least one non-aromatic alkene, alkyne, C1-C13-alkyl, or an aromatic moiety;
q is an integer of 1 to 5;
r is independently 0 or an integer of 1 to 4,
u is independently 0, or an integer greater than or equal to 1, when u is 0, the bracket region represents a bond, and
n is 0 or an integer greater than or equal to 1, when n is 0, the bracket region represents a bond;
2) optionally a container (B) comprising at least one di- or polyfunctional resin (B); and
3) optionally a container (C);
wherein the kit further comprises a catalyst (C), which is comprised in container (A), container (B), and/or container (C).

The inventors of the present invention surprisingly found that at least one of the above objects can be achieved by the cyclopentadiene based resin as disclosed herein. In this connection, the present invention e.g. provides a time-efficient (fast curing) method for producing fiber-reinforced parts having well balanced properties with regards to e.g. Tg, mechanic properties, and/or electronic properties.

### DETAILED DESCRIPTION OF PREFERRED EMBODIMENTS

In the following, the invention will be explained in more detail.

The terms “about” in the context of the present invention denotes an interval of accuracy that a person skilled in the art will understand to still ensure the technical effect of the feature in question. The term typically indicates a deviation from the indicated numerical value of ±10%, preferably ±5%, more preferably ±2%, and in particular ±1%.

As used herein, the articles “a” and “an” preceding an element or component are intended to be nonrestrictive regarding the number of instances (i.e. occurrences) of the element or component. Therefore, “a” or “an” is to be read to include one or at least one, and the singular word form of the element or component also includes the plural unless the number is obviously meant to be singular.

The organic moieties mentioned in the above definitions of the variables are—like the term halogen—collective terms for individual listings of the individual group members. The prefix Cn-Cm indicates in each case the possible number of carbon atoms in the group.

The term “halogen” as used herein refers to fluorine, chlorine, bromine, or iodine, preferably fluorine, chlorine, or bromine.

The term “substituted bisimide” as used herein refers to compounds with substitutions at the C—C double bond (3 and/or 4 position) of the maleimide-group.

The term “alkyl” (either alone or as part of a larger group, such as alkoxy) as used herein denotes in each case a linear (i.e. straight-chain) or branched saturated hydrocarbon group having usually from 1 to 20 carbon atoms, preferably 1 to 10, or 1 to 6, or 1 to 4 carbon atoms, more preferably 1 to 3 or 1 to 2 or 1 carbon atoms. Examples of an alkyl group are methyl, ethyl, n-propyl, iso-propyl, n-butyl, 2-butyl, iso-butyl, tert-butyl, n-pentyl, 1-methylbutyl, 2-methylbutyl, 3-methyl-butyl, 2,2-dimethylpropyl, 1-ethylpropyl, n-hexyl, 1,1-dimethylpropyl, 1,2-dimethylpropyl, 1-methylpentyl, 2-methylpentyl, 3-methylpentyl, 4-methylpentyl, 1,1-dimethylbutyl, 1,2-dimethyl-butyl, 1,3-dimethylbutyl, 2,2-dimethylbutyl, 2,3-dimethylbutyl, 3,3-dimethylbutyl, 1-ethylbutyl, 2-ethylbutyl, 1,1,2-trimethylpropyl, 1,2,2-trimethylpropyl, 1-ethyl-1-methylpropyl, 1-ethyl-2-methylpropyl, and the like.

The term “linear C1-C10-alkyl” refers to a straight-chained saturated hydrocarbon group having 1 to 10 carbon atoms including methyl, ethyl, propyl, butyl, pentyl, hexyl, heptyl, octyl, nonyl, and decyl.

The term “branched C4-C10-alkyl” refers to a branched-chained saturated hydrocarbon group having 4 to 10 carbon atoms including 1-methylpropyl, 2-methylpropyl, 1,1-dimethylethyl, 1-methylbutyl, 2-methylbutyl, 3-methylbutyl, 2,2-dimethylpropyl, 1-ethylpropyl, 1,1-dimethylpropyl, 1,2-dimethylpropyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl, 1-ethylbutyl, 2-ethylbutyl, 1,1,2-trimethyl propyl, 1,2,2-trimethylpropyl, 1-ethyl-1-methylpropyl, and 1-ethyl-2-methylpropyl.

The term “haloalkyl” as used herein denotes in each case a linear (i.e. straight-chain) or branched saturated hydrocarbon group having usually from 1 to 20 carbon atoms, frequently from 1 to 10, or 1 to 6, or 1 to 4 carbon atoms, wherein the hydrogen atoms of this group are partially or totally replaced with halogen atoms. Preferred haloalkyl moieties are selected from C1-C4-haloalkyl, more preferably from C1-C3-haloalkyl or C1-C2-haloalkyl, in particular from C1-C2-fluoroalkyl such as fluoromethyl, difluoromethyl, trifluoromethyl, 1-fluoroethyl, 2-fluoroethyl, 2,2-difluoroethyl, 2,2,2-trifluoroethyl, pentafluoroethyl, and the like. The term “halogenated” as used herein denotes in each case that in the respective moiety (e.g. in a halogenated C3-C8-cycloalkyl) at least one hydrogen atom is replaced with at least one halogen atom.

The term “alkenyl” (either alone or as part of a larger group, e.g. alkenyloxy) as used herein denotes in each case a linear (i.e. straight-chain) or branched hydrocarbon group having usually from 2 to 20 carbon atoms, frequently from 2 to 10, 2 to 6, or 2 to 4 carbon atoms, with one or more C═C double bonds. The alkenyl moieties, where appropriate, can be of either the (E)- or (Z)-configuration.

The term “linear C2-C10-alkenyl” refers to linear groups with one or more double bonds, wherein the alkenyl moieties, where appropriate, can be of either the (E)- or (Z)-configuration. Examples of “linear C2-C10-alkenyl” groups include vinyl, allyl, propenyl, butenyl, pentenyl, hexenyl, heptenyl, and octenyl.

The term “branched C3-C10-alkenyl” refers to branched groups with one or more double bonds, wherein the alkenyl moieties, where appropriate, can be of either the (E)- or (Z)-configuration. The branching site can either be at an unsaturated, or at a saturated carbon atom. Examples of “branched C3-C10-alkenyl” groups include isopropenyl, sec-butenyl, tert-butenyl, isopentenyl, and isohexenyl.

“Alkynyl” substituents (also referred to as “alkyne”; either alone or as part of a larger group, e.g. alkynyloxy) as used herein denotes in each case a linear (i.e. straight-chain) or branched hydrocarbon group having usually from 2 to 20 carbon atoms, frequently from 2 to 10, 2 to 6, or 2 to 4 carbon atoms, with one or more C≡C triple bonds.

The term “alkoxy” as used herein denotes in each case alkyl substituents as defined above that are connected to another structural moiety via an oxygen atom (—O—). Exemplary alkoxy groups are methoxy, trifluoromethoxy, ethoxy, 2,2,2-trifluoroethoxy, n-propoxy, iso-propoxy, n-butoxy, sec-butoxy, tert-butoxy, n-pentoxy.

The term “alkylthio” as used herein denotes in each case alkyl substituents as defined above that are connected to another structural moiety via a sulphur atom (—S—). An exemplarily alklythio group is methylthio.

The term “aryl” (either alone or as part of a larger group, such as e.g. aryloxy, aralkyl) as used herein refers to aromatic ring systems (i.e. fulfilling the Hückel rule—having (4n+π2) electrons, with n being 0 or an integer of preferably 1 to 3) which can be in mono-, bi- or tricyclic form. Examples of such rings include phenyl, naphthyl, anthracenyl, indenyl or phenanthrenyl. Preferred aryl groups are phenyl and naphthyl, phenyl being most preferred.

The term “aromatic group” as used herein refers to a bivalent group comprising at least one aromatic ring system. An “aromatic group having between 1 and 20 carbon atoms” refers to a bivalent group having between 1 and 20 carbon atoms and comprising at least one aromatic ring system. The group may be fully aromatic, such as a phenylene, or may comprise at least two bivalent aromatic ring systems that are connected via a bond such as phenylene-phenylene.

The term “alkylene” or “alkanediyl” as used herein refers to a bivalent linear or branched alkyl group, e.g. —(CH2)x- or —CH(CH3)CH2-, wherein x is a positive integer of usually 1 to 20, preferably 1 to 10 or 1 to 5. In the context of the present invention “C1-C5-alkylene” refers to an alkylene moiety with 1, 2, 3, 4, and 5, respectively, carbon atoms, e.g. —CH2-groups; the term “alkylene”, however, not only comprises linear alkylene groups, i.e. “alkylene chains”, but branched alkylene groups, as well. The term “C1-C5-alkylene” refers to an alkylene moiety that is either linear, i.e. an alkylene chain, or branched and has 1, 2, 3, 4, or 5 carbon atoms.

The term “cycloalkanediyl” as used herein denotes carbocyclic rings having e.g. 3 to 8 carbon atoms. Cycloalkanediyl groups having the open valencies on different carbon atoms may occur in cis and trans isomeric forms.

The term “aralkyl” as used herein refers to an alkyl moiety as defined herein that is substituted by an aryl moiety as defined herein. The term “bivalent aralkyl” as used herein refers to an aralkyl moiety as defined herein, which has two binding sites to the remainder of the molecule.

The term “alkaryl” as used herein refers to an aryl moiety as defined herein that is substituted by an alkyl moiety as defined herein. The term “bivalent alkaryl” as used herein refers to an alkaryl moiety as defined herein, which has two binding sites to the remainder of the molecule.

The term “alkenylaryl” as used herein refers to an aryl moiety as defined herein that is substituted by an alkenyl moiety as defined herein.

The term “bisaralkyl” as used herein refers to an alkyl moiety as defined herein that is substituted by two aryl moiety as defined herein. The term “bivalent bisaralkyl” as used herein refers to an bisaralkyl moiety as defined herein, which has two binding sites to the remainder of the molecule.

The term “3 to 8 membered cycloalkyl” or “C3-C8-cycloalkyl” refers to saturated carbocyclic compounds that can include one or more rings. Examples of “3 to 8 membered cycloalkyl” or “C3-C8-cycloalkyl” groups include cyclopropyl, cyclobutyl, cyclopentyl, cyclohexyl, cycloheptyl, cyclooctyl, norbonyl, and bicyclo[2.2.2]octyl.

The term “3 to 8 membered cycloalkenyl” refers to unsaturated (i.e. being partially unsaturated or aromatic) carbocyclic compounds that can include one or more rings. Examples of “3 to 8 membered cycloalkenyl” groups include cyclopropenyl, cyclopropyl, cyclobutenyl, cyclopentenyl, cyclohexenyl, cycloheptenyl, cyclooctenyl, norbonenyl, bicyclo[2.2.2]octenyl, and phenyl.

It is to be understood that the alkyl, cycloalkyl, alkyne, aryl, aralkyl, alkenylaryl, alkaryl, linear C1-C10-alkyl, linear C1-C10-haloalkyl, branched C4-C10-alkyl, branched C4-C10-haloalkyl, C3-C8-cycloalkyl, halogenated C3-C8-cycloalkyl, linear C2-C10-alkenyl, branched C3-C10-alkenyl, C1-C10-alkoxy, phenyl, phenoxy, 3 to 8 membered cycloalkyl, and 3 to 8 membered cycloalkenyl may optionally be further substituted. Exemplary substituents include hydroxy, carboxy, amino, sulfonyl, halogen, and phenyl-group. In a preferred embodiment, the aforementioned moieties are not further substituted.

The term “polymer” as used herein encompasses copolymers and homopolymers.

The expression “liquid mixture” means a mixture that is liquid at ambient temperature (typically about 25 °C and/or by Brookfield viscosimeter) and has a viscosity of preferably less than 10,000 mPa×s at ambient temperature and preferably less than 2,000 mPa×s, more preferably less than 1,000 mPa×s, and most preferably no more than about 500 mPa×s at a temperature of 80 °C or less.

It needs to be understood that the term “comprising” is not limiting. For the purposes of the present invention, the term “consisting of” is considered to be a preferred embodiment of the term “comprising of”. If hereinafter a group is defined to comprise at least a certain number of embodiments, this is also meant to encompass a group which preferably consists of these embodiments only.

As outlined above, subject of the present invention is in a first aspect a method for preparing a fiber-reinforced part comprising the steps of
(i) providing a resin composition (RC) comprising
a) a hydrocarbon resin composition (HRC) derived from a hydrocarbon resin having a structure as defined by formula (A3)

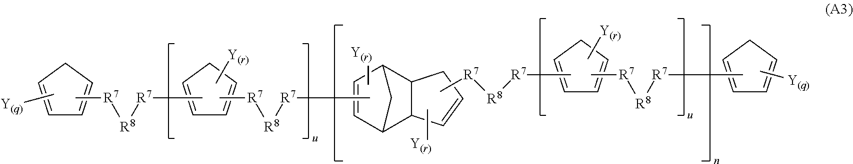

wherein
R⁷ is independently a methylene group (CH₂) or a methylene group substituted with one or more —CH₃ or halogen functionalities;
R⁸ is independently a bond or a straight-chain or branched, linear or cyclic, saturated or unsaturated, substituted or unsubstituted, aliphatic or aromatic group having between 1 and 20 carbon atoms,
Y is independently a functionality possessing at least one non-aromatic alkene, alkyne, C1-C13-alkyl, or an aromatic moiety;
q is an integer of 1 to 5;
r is independently 0 or an integer of 1 to 4,
u is independently 0, or an integer greater than or equal to 1, when u is 0, the bracket region represents a bond, and
n is 0 or an integer greater than or equal to 1, when n is 0, the bracket region represents a bond;
b) optionally at least one di- or polyfunctional resin (B); and
c) a catalyst (C);
(ii) providing a fiber structure;
(iii) contacting said fiber structure with said resin composition (RC) providing a fiber composition (FC); and
(iv) curing said fiber composition (FC).

The inventive method provides a time-efficient method for producing fiber-reinforced parts having well-balanced properties, e.g. that withstand high thermal stress and/or show excellent electronic properties.

In the following, particular embodiments of the present invention such as preferred ingredients and preferred method steps are described in further details. It is to be understood that each embodiment is relevant on its own as well as in combination with other embodiments.

The skilled person will understand that R⁷ and R⁸ are bivalent groups, i.e. that the respective groups have two binding sites to the remainder of the molecule.

In one embodiment, step (ii) further comprises placing said fiber structure in a mold or on a substrate.

In one embodiment, the contacting in step (iii) is an impregnating, i.e, wherein the fiber structure is impregnated with the resin composition (RC).

In one embodiment, the impregnation in step (iii) is achieved using a method selected from the group consisting of resin transfer molding, vacuum assisted resin transfer molding, liquid resin infusion, Seemann Composites Resin Infusion Molding Process, vacuum assisted resin infusion, injection molding, compression molding, spray molding, pultrusion, laminating, filament winding, Quickstep process or Roctool process, preferably selected from the group consisting of resin transfer molding, vacuum assisted resin transfer molding, liquid resin infusion, vacuum assisted resin infusion, injection molding, or filament winding. More preferably, the impregnation in step (iii) is achieved using a liquid composite molding process method selected from the group consisting of resin transfer molding, liquid resin infusion, Seemann Composites Resin Infusion Molding Process, vacuum assisted resin infusion, injection molding, EADS vacuum assisted process (VAP®), and vacuum assisted resin transfer molding, and in particular selected from the group consisting of vacuum assisted resin transfer molding and injection molding or selected from the group consisting of injection molding.

Filament Winding is a process, which is generally applied for epoxy resins and polyesters. So far, cyclopentadien and blends thereof have not been applied to this method. For the production of pressure vessels and convex geometries from composite materials, filament winding is one of the most competitive technologies. The industrially available impregnation method for the filament winding comprises the impregnation of the fibers in an open bath. During the impregnation process the roving has to be spread out in order to completely wet the single fiber filaments of the roving. A filament winding apparatus then winds the tensioned and resin-impregnated fiber bundle around a mandrel, which defines the shape and dimensions of the final product. The fiber bundles are applied under tension in order to achieve a high fiber/resin volume ratio on the composite.

For filament winding the resin composition should have a viscosity of less than about 1000 mPa×s, preferably no more than about 500 mPa×s, at the impregnation temperature. The reinforcement structures (made e. g. of glass, carbon, or aramid fibers) are impregnated in a resin bath with all components mixed. Complete and uniform impregnation of the reinforcing fibers is of crucial importance in the filament winding process.

By using a catalysts the viscosity of the mixture can be further reduced, which helps to operate the resin bath at a lower temperature. In order to achieve a certain and economical curing process a certain concentration of the catalysts is applied. The concentration guarantees that the produced (e.g. cylindrical or elliptical) part can be cured at much lower temperature than a pure hydrocarbon resin (without catalyst) which results in lower internal stress and higher part quality. Gelation time and cure time can be designed very precisely and the curing time overall can be reduced considering the reactivity data given in the working examples below.

In one embodiment, in step (iii) a temperature of about 20 to about 95 °C, preferably of about 22 to about 89 °C, more preferably of about 24 to about 85 °C, and in particular of about 25 to about 50 °C or of about 60 to about 85 °C, is applied.

In one embodiment, in step (iii) an elevated pressure is applied and/or the air is evacuated.

In one embodiment, in step (iii) a pressure of about 1 to about 20 hPa, preferably of about 2 to about 16 hPa, and in particular of about 3 to about 12 hPa, is applied. In this connection, the pressure is preferably applied for about 5 to about 120 min, more preferably for about 7 to about 100 min, and in particular for about 10 to about 60 min. The pressure can be kept during the curing.

In one embodiment, the resin composition (RC) is treated with a pressure of about 1 to about 15 hPa, preferably of about 2 to about 10 hPa, and in particular of about 3 to about 6 hPa, prior to contacting step (iii), preferably for about 1 to about 30 min, more preferably for about 2 to about 20 min, and in particular for about 3 to about 15 min.

The curing step (iv) may be performed using any heating technique, including conventional techniques as well as innovative techniques such as Quickstep or Roctool processes. The time required for curing the resin composition (RC) (e.g. being a liquid mixture) depends on its composition and the curing temperature, it is typically in the range of about one hour to about 20 hours. Curing step (iv) can involve different curing cycles. A skilled person can easily determine suitable curing conditions based on the guidance given by the working examples below.

In one embodiment, in step (iv) a temperature of about 30 to about 150 °C, preferably of about 40 to about 140 °C, still more preferably of about 50 to about 130 °C, and in particular of about 60 to about 125 °C, is applied. Preferably, curing in step (iv) is conducted for up to about 48 hours, more preferably for about 0.1 to about 48 hours, still more preferably for about 0.2 to about 24 hours, and in particular for about 0.3 to about 8 hours.

The temperature change between step (iii) and step (iv) can be obtained via a temperate ramp.

In one embodiment, the method further comprises step (v) post-curing of the product obtained in step (iv). The post-curing may be performed using any heating technique, including conventional techniques as well as innovative techniques and is preferably conducted at a temperature of up to about 300 °C, preferably for up to about 10 hours. Preferably, post-curing is conducted at a temperature of about 150 to about 300 °C, more preferably of about 180 to about 300 °C, still more preferably of about 180 to about 250 °C, and in particular of about 180 to about 230 °C. In this connection, post-curing is preferably conducted for about 0.1 to 10 hours, more preferably for about 0.5 to about 9 hours, and in particular for about 3 to about 9 hours or for about 1 to about 6 hours. Post-curing can involve different curing cycles. A skilled person can easily determine suitable post-curing conditions based on the guidance given by the working examples below.

In one embodiment, the method comprises
(i) providing the resin composition (RC), which is a liquid mixture;
(ii) providing a fiber structure and placing said fiber structure in a mold or on a substrate;
(iii) impregnating said fiber structure with said liquid mixture, optionally by applying elevated pressure and/or evacuating the air from the mold and fiber structure, at a temperature of about 20 to about 95 °C;
(iv) curing said liquid mixture by applying a temperature of about 30 to about 150 °C for a time sufficient to cure said liquid mixture; and
(v) optionally post-curing of the product obtained in step (iv).

In curing step (iv), the temperature and time is preferably sufficient to achieve a degree of conversion that allows demolding of the parts.

In one embodiment, the fiber-reinforced part obtained in step (iv) exhibits a high-temperature resistance, as given by the Tg value (determined by Tg onset via TMA measurement) of preferably more than 100 °C, more preferably more than about 110 °C, and in particular more than about 120 °C, after step (iv). In a preferred embodiment, the fiber-reinforced part obtained in step (iv) exhibits a Tg value (determined by Tg onset via TMA measurement) of about 100 to about 220 °C; preferably of about 110 to about 200 °C, and in particular of about 120 to about 160 °C. In general, Tg may also be determined by tan δ measurement via DMA.

The curing step (iv) may be performed via irradiation such as irradiating with UV-Vis light, preferably having a wavelength of 10 to 500 nm, more preferably of 100 to 450 nm, and in particular of 280 to 400 nm. The resin composition (RC) is suitably irradiated for 0.1 to 3 hours, preferably for 0.1 to 2.5 hours, more preferably for 0.2 to 2 hours, still more preferably for 0.4 to 1.2 hours.

A post-curing step (v) can directly follow the cure cycle and/or be applied once the part is removed from the mold (freestanding). Preferably a post-cure is applied freestanding by applying a temperature sufficient to achieve very high degree of conversion and, respectively, an optimal thermal resistance.

In one embodiment, the fiber-reinforced part obtained in step (v) exhibits a Tg value (determined by Tg onste via TMA measurement) of more than about 170 °C, preferably of more than about 180 °C, and in particular of more than 200 °C, after step (v). In a preferred embodiment, the fiber-reinforced part obtained in step (v) exhibits a Tg value (determined by Tg onste via TMA measurement) of about 170 to about 400 °C; preferably of about 180 to about 350 °C, and in particular of about 190 to about 300 °C.

In one embodiment, fiber-reinforced part has a dissipation (Df) value of about 0.0001 to about 0.004.

In one embodiment, fiber-reinforced part has a dielectric (Dk) value of about 1.5 to about 3 at 1-50 GHz.

In one embodiment, Y is independently vinylbenzyl, propenylbenzene, ethenylbenzene, (methyl) ethenylbenzene, styrenyl, allyl, propargyl, butenyl, or benzyl, preferably independently allyl or benzyl.

In one embodiment Y is independently selected from the group consisting of

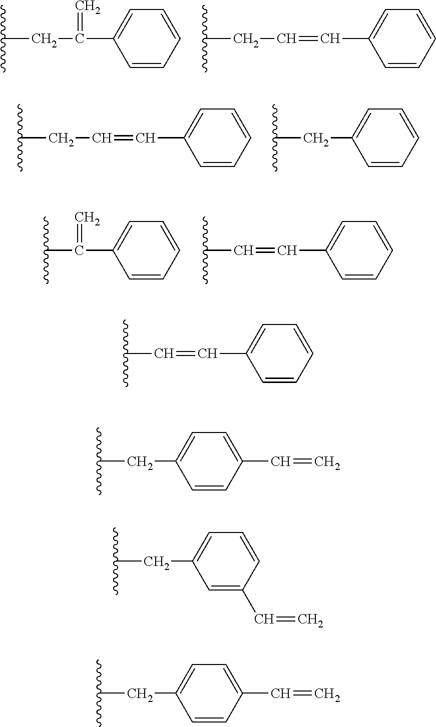

and isomers thereof.

In one embodiment, Y is independently selected from the group consisting of

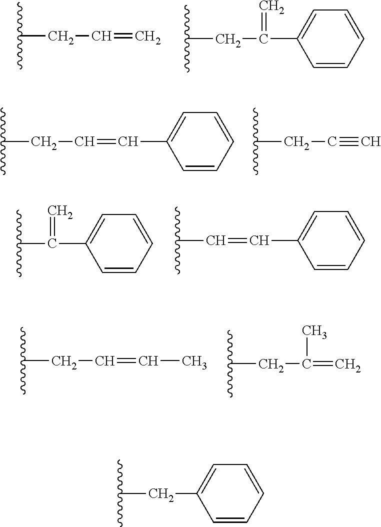

and isomers thereof.

In one embodiment, at least one Y is

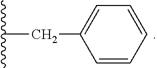 [SMILES: *Cc1ccccc1]

In one embodiment, Y is independently selected from the group consisting of

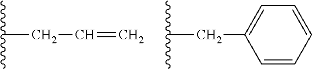

and isomers thereof.

In one embodiment, Y is independently C2-C20 alkenyl, C2-C20 alkynyl, or C8-C20 alkenylaryl, preferably C2-C12 alkenyl, C2-C12 alkynyl, or C8-C18 alkenylaryl, still more preferably C2-C8 alkenyl, C2-C8 alkynyl, or C8-C12 alkenylaryl, and in particular C2-C4 alkenyl or C8-C12 alkenylaryl.

In one embodiment,
R⁷ is a methylene group (CH₂) and/or
R⁸ is independently a bond, a substituted or unsubstituted C6 aromatic group, a substituted or unsubstituted C10 aromatic group, or a substituted or unsubstituted C12 aromatic group.

Suitably, the substituted or unsubstituted C6 aromatic group is an unsubstituted phenylene or a phenylene substituted with e.g. hydroxyl and/or halogen (e.g. fluorine) such as tetrafluorophenylene.

Suitably, the substituted or unsubstituted C10 aromatic group is a substituted C10 aromatic group such as substituted with hydroxy and/or halogen (e.g. fluorine), preferably a bivalent naphthol.

Suitably, the substituted or unsubstituted C12 aromatic group is a substituted or unsubstituted phenylene-phenylene.

In one embodiment,
r is independently 0 or an integer of 1 to 3, more preferably 0, 1, or 2, and in particular 0 or 1.

In one embodiment,
u is independently 0 or an integer of 1 to 200, preferably wherein u is 0 or an integer of 1 to 100, and in particular wherein u is 0 or an integer of 1 to 50; and/or
q is an integer of 1 to 4, preferably of 1 to 3, more preferably of 1 or 2, and in particular 1.

In one embodiment, the hydrocarbon resin composition (HRC) comprises
a.1) a hydrocarbon resin having a structure as defined by formula (A1)

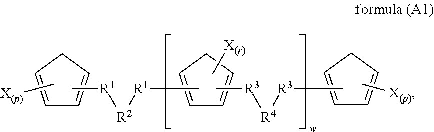

wherein
R¹ is independently a methylene group (CH₂) or a methylene group substituted with one or more —CH₃ or halogen,
R² is a bond or a substituted or unsubstituted C1-C20 alkylene,
R³ is independently a methylene group (CH₂) or a methylene group substituted with one or more —CH₃ or halogen,
R⁴ is independently a bond or a substituted or unsubstituted C1-C20 alkylene, C4-C20 aromatic group, or saturated or unsaturated C4-C20 cyclic group,
X is independently a functionality possessing at least one non-aromatic alkene, alkyne, C1-C13 alkyl, or an aromatic moiety,
p is independently an integer of 1 to 5,
r is independently 0 or an integer of 1 to 4, and
w is 0 or an integer of 1 to 50 and when w is 0, the bracket region represents a bond.

In one embodiment, the hydrocarbon resin composition (HRC) comprises a.2) a hydrocarbon resin having a structure as defined by formula (A2)

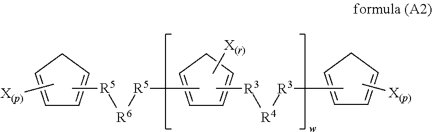

wherein
R³ is independently a methylene group (CH₂) or a methylene group substituted with one or more —CH₃ or halogen,
R⁴ is independently a bond or a substituted or unsubstituted C1-C20 alkylene, C4-C20 aromatic group, or saturated or unsaturated C4-C20 cyclic group,
R⁵ is independently a methylene group (CH₂) or a methylene group substituted with one or more —CH₃ or halogen,
R⁶ is a substituted or unsubstituted C4-C20 aromatic group or saturated or unsaturated C4-C20 cyclic group,
X is independently a functionality possessing at least one non-aromatic alkene, alkyne, C1-C13 alkyl, or an aromatic moiety,
p is independently an integer of 1 to 5,
r is independently 0 or an integer of 1 to 4, and
w is 0 or an integer of 1 to 50 and when w is 0, the bracket region represents a bond.

In a preferred embodiment, the hydrocarbon resin composition (HRC) comprises at least two of (A1) to (A3)
a.1) a hydrocarbon resin having a structure as defined by formula (A1)

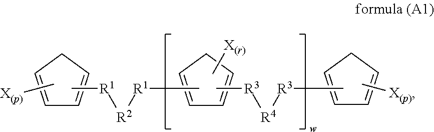

wherein
R¹ is independently a methylene group (CH₂) or a methylene group substituted with one or more —CH₃ or halogen,
R² is a bond or a substituted or unsubstituted C1-C20 alkylene,
R³ is independently a methylene group (CH₂) or a methylene group substituted with one or more —CH₃ or halogen,
R⁴ is independently a bond or a substituted or unsubstituted C1-C20 alkylene, C4-C20 aromatic group, or saturated or unsaturated C4-C20 cyclic group,
X is independently a functionality possessing at least one non-aromatic alkene, alkyne, C1-C13 alkyl, or an aromatic moiety,
p is independently an integer of 1 to 5,
r is independently 0 or an integer of 1 to 4, and
w is 0 or an integer of 1 to 50 and when w is 0, the bracket region represents a bond;
a.2) a hydrocarbon resin having a structure as defined by formula (A2)

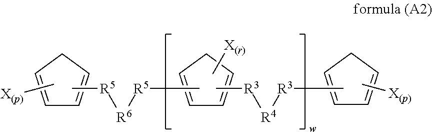

wherein
R³ is independently a methylene group (CH₂) or a methylene group substituted with one or more —CH₃ or halogen,
R⁴ is independently a bond or a substituted or unsubstituted C1-C20 alkylene, C4-C20 aromatic group, or saturated or unsaturated C4-C20 cyclic group,
R⁵ is independently a methylene group (CH₂) or a methylene group substituted with one or more —CH₃ or halogen,
R⁶ is a substituted or unsubstituted C4-C20 aromatic group or saturated or unsaturated C4-C20 cyclic group,
X is independently a functionality possessing at least one non-aromatic alkene, alkyne, C1-C13 alkyl, or an aromatic moiety,
p is independently an integer of 1 to 5,
r is independently 0 or an integer of 1 to 4, and
w is 0 or an integer of 1 to 50 and when w is 0, the bracket region represents a bond; and
a.3) a polymer, prepolymer, or oligomer derived from a hydrocarbon resin having a structure defined by formula (A3)

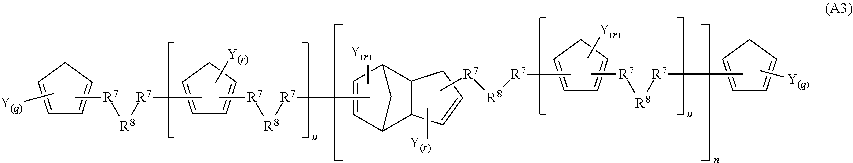

wherein
R⁷ is independently a methylene group (CH₂) or a methylene group substituted with one or more —CH₃ or halogen functionalities,
R⁸ is independently a bond or a straight-chain or branched, linear or cyclic, saturated or unsaturated, substituted or unsubstituted, aliphatic or aromatic group having between 1 and 20 carbon atoms,
Y is independently a functionality possessing at least one non-aromatic alkene, alkyne, C1-C13-alkyl, or an aromatic moiety,
q is an integer of 1 to 5,
r is independently 0 or an integer of 1 to 4,
u is independently 0, or an integer greater than or equal to 1, when u is 0, the bracket region represents a bond, and
n is 0 or an integer greater than or equal to 1, when n is 0, the bracket region represents a bond.

In line with the above, the skilled person will understand that R¹ to R⁸ are bivalent groups, i.e. that the respective groups have two binding sites to the remainder of the molecule.

In one embodiment, X and/or Y is independently vinylbenzyl, propenylbenzene, ethenylbenzene, (methyl) ethenylbenzene, styrenyl, allyl, propargyl, butenyl, or benzyl, preferably independently allyl or benzyl.

In one embodiment, X and/or Y is independently selected from the group consisting of

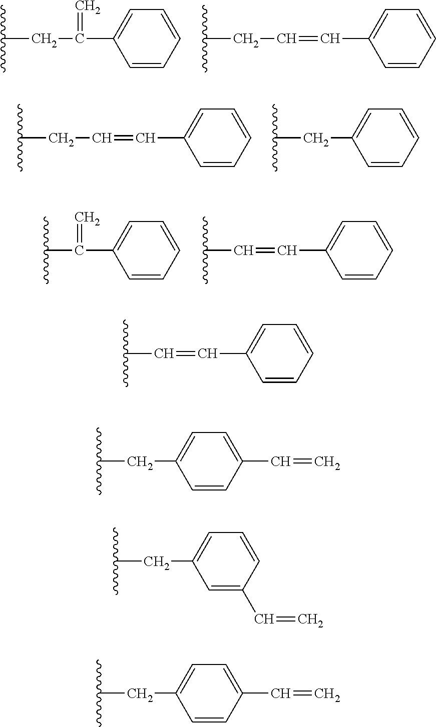

and isomers thereof.

In one embodiment, X and/or Y is independently selected from the group consisting of

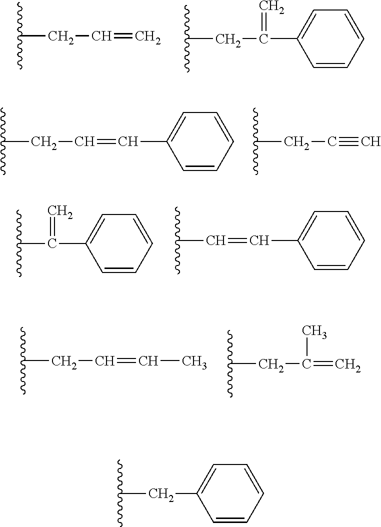

and isomers thereof.

In one embodiment, at least one X and/or Y is

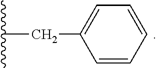 [SMILES: *Cc1ccccc1]

In one embodiment, X and/or Y is independently selected from the group consisting of

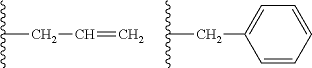

and isomers thereof.

In one embodiment, X and/or Y is independently C2-C20 alkenyl, C2-C20 alkynyl, or C8-C20 alkenylaryl, preferably C2-C12 alkenyl, C2-C12 alkynyl, or C8-C18 alkenylaryl, still more preferably C2-C8 alkenyl, C2-C8 alkynyl, or C8-C12 alkenylaryl, and in particular C2-C4 alkenyl or C8-C12 alkenylaryl.

In one embodiment,
R¹, R³, R⁵, and R⁷ are a methylene group (CH₂) and/or
R⁴ and R⁸ are independently a bond, a substituted or unsubstituted C6 aromatic group, a substituted or unsubstituted C10 aromatic group, or a substituted or unsubstituted C12 aromatic group.

Suitably, the substituted or unsubstituted C6 aromatic group is an unsubstituted phenylene or a phenylene substituted with e.g. hydroxyl and/or halogen (e.g. fluorine) such as tetrafluorophenylene.

Suitably, the substituted or unsubstituted C10 aromatic group is a substituted C10 aromatic group such as substituted with hydroxy and/or halogen (e.g. fluorine), preferably a bivalent naphthol.

Suitably, the substituted or unsubstituted C12 aromatic group is substituted or unsubstituted phenylene-phenylene. In one embodiment, R² is a bond or a C1-C10 alkylene, preferably a bond or a C1-C5-alkylene, more preferably a bond or a C1-C2 alkylene, and in particular a bond.

In one embodiment,
R⁶ is a substituted or unsubstituted C4-C18 aromatic group or a substituted or unsubstituted C4-C16 saturated or unsaturated cyclic group, preferably a substituted or unsubstituted C4-C16 aromatic group or a substituted or unsubstituted C4-C10 saturated or unsaturated cyclic group, more preferably a substituted or unsubstituted C6 aromatic group, a substituted or unsubstituted C10 aromatic group, a substituted or unsubstituted C12 aromatic group, a substituted or unsubstituted C13 aromatic group, a substituted or unsubstituted C14 aromatic group, a substituted or unsubstituted C5 saturated cyclic group, or a substituted or unsubstituted C6 saturated cyclic group, and in particular a substituted or unsubstituted C6 aromatic group, a substituted C10 aromatic group, or a C12 aromatic group.

In one embodiment,
w is 0 or an integer of 1 to 20, preferably wherein w is 0 or an integer of 1 to 5, and in particular wherein w is 0; and/or
p is an integer of 1 to 4, preferably of 1 to 3, more preferably of 1 or 2, and in particular 1; and/or
r is independently 0 or an integer of 1 to 3, more preferably 0, 1, or 2, and in particular 0 or 1.

In one embodiment, the hydrocarbon resin composition (HCR) comprises
a.1) a hydrocarbon resin having a structure as defined by formula (A1)

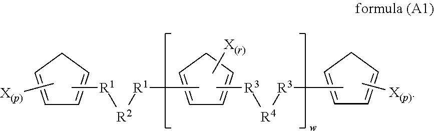

In one embodiment, the hydrocarbon resin composition (HCR) comprises
a.1) a hydrocarbon resin having a structure as defined by formula (A1-1)

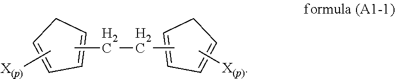

In one embodiment, the hydrocarbon resin composition (HCR) comprises
a.2) a hydrocarbon resin having a structure as defined by formula (A2)

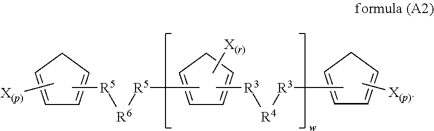

In one embodiment, the hydrocarbon resin composition (HCR) comprises (A2), wherein R⁶ is a substituted C6 aromatic group or a substituted or unsubstituted C12 aromatic group, preferably wherein R⁵ is a methylene group (CH₂), more preferably wherein the hydrocarbon resin composition (HCR) comprises
a.2) a hydrocarbon resin having a structure as defined by formula (A2-2)

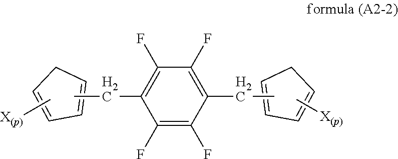

and/or
a hydrocarbon resin having a structure as defined by formula (A2-3)

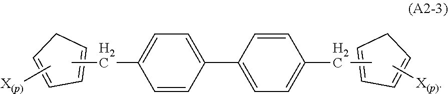

In this connection, it is to be understood that the hydrocarbon resin composition (HCR) comprising (A2), wherein R⁶ is a substituted C6 aromatic group or a substituted or unsubstituted C12 aromatic group, can comprise at least one different hydrocarbon resin (A2) (wherein R⁶ is a substituted or unsubstituted C4-C20 aromatic group or saturated or unsaturated C4-C20 cyclic group) such as a hydrocarbon resin having a structure as defined by formula (A2-1).

In one embodiment, the hydrocarbon resin composition (HCR) comprises
a.2) a hydrocarbon resin having a structure as defined by formula (A2-1)

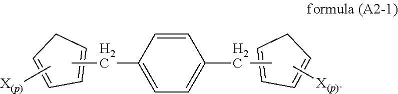

In one embodiment, the hydrocarbon resin composition (HCR) comprises
a.2) a hydrocarbon resin having a structure as defined by formula (A2-2)

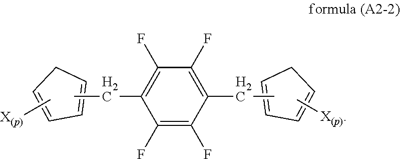

In one embodiment, the hydrocarbon resin composition (HCR) comprises
a.2) a hydrocarbon resin having a structure as defined by formula (A2-3)

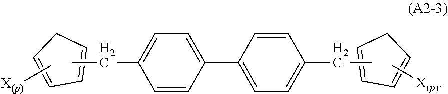

In one embodiment, the hydrocarbon resin composition (HCR) comprises a hydrocarbon resin having a structure as defined by formula (A2-1)

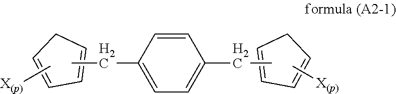

and a hydrocarbon resin having a structure as defined by formula (A2-3)

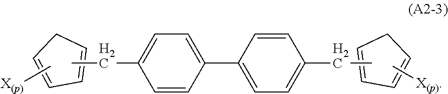

In one embodiment, the hydrocarbon resin composition (HCR) comprises
a.3) a polymer, prepolymer, or oligomer derived from a hydrocarbon resin having a structure defined by formula (A3)

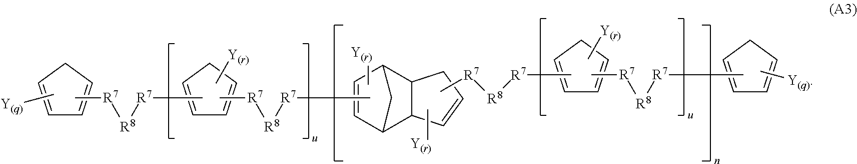

In one embodiment, the hydrocarbon resin composition (HCR) comprises at least (A1) and (A2).

In one embodiment the hydrocarbon resin composition (HCR) comprises at least two different hydrocarbon resin having a structure as defined by formula (A2). These at least two different hydrocarbon resin differ at least in one moiety (R³, R⁴, R⁵, R⁶, X, p, r, and w) and may be denoted as (A2-X) and (A2-Y). Suitably, the at least two different hydrocarbon resin may be a hydrocarbon resin having a structure as defined by formula (A2-1) and a hydrocarbon resin having a structure as defined by formula (A2-3). If present, the at least two different hydrocarbon resin (A2-X) and (A2-Y) generally have a weight ratio of 100:1 to 1:100, preferably of 50:1 to 1:15, more preferably of 10:1 to 1:10 such as of 4:1 to 1:4, or of 3:1 to 1:3, or of 2:1 to 1:2, or of 1.5:1 to 1:1.5, or of 1.2:1 to 1:1.2. In this connection, the hydrocarbon resin composition (HCR) may additionally comprises (A1).

In one embodiment, the hydrocarbon resin composition (HCR) comprises at least (A1) and a polymer, prepolymer, or oligomer derived from a hydrocarbon resin having a structure defined by formula (A3).

In one embodiment, the hydrocarbon resin composition (HCR) comprises at least (A2) and a polymer, prepolymer, or oligomer derived from a hydrocarbon resin having a structure defined by formula (A3).

In one embodiment, the hydrocarbon resin composition (HCR) comprises (A1), (A2), and a polymer, prepolymer, or oligomer derived from a hydrocarbon resin having a structure defined by formula (A3).

In one embodiment, the hydrocarbon resin composition (HCR) comprises (A1), (A2-X), (A2-Y), and a polymer, prepolymer, or oligomer derived from a hydrocarbon resin having a structure defined by formula (A3).

In one embodiment, the polymer, prepolymer, or oligomer derived from a hydrocarbon resin having
a structure defined by formula (A3) is present and wherein preferably
u is independently 0 or an integer of 1 to 200, preferably wherein u is 0 or an integer of 1 to 100, and in particular wherein u is 0 or an integer of 1 to 50; and/or
q is an integer of 1 to 4, preferably of 1 to 3, more preferably of 1 or 2, and in particular 1.

In one embodiment, the hydrocarbon resin composition (HRC) comprises the hydrocarbon resin having a structure as defined by formula (A1) and the hydrocarbon resin having a structure as defined by formula (A2) in a weight ratio of 100:1 to 1:100, preferably of 50:1 to 1:15, more preferably of 10:1 to 1:10 such as of 4:1 to 1:4, or of 3:1 to 1:3, or of 2:1 to 1:2, or of 1.5:1 to 1:1.5, or of 1.2:1 to 1:1.2.

In one preferred embodiment, the resin composition (RC) substantially comprises, preferably consists of, a hydrocarbon resin composition (HRC) derived from a hydrocarbon resin having a structure as defined by formula (A3).

In another preferred embodiment, the resin composition (RC) comprises
b) at least one di- or polyfuncational resin (B), preferably selected from the group consisting of epoxy resin, oxetan resin, bismaleimide resin, cyanate ester resin, diene resin, bisbenzocyclobutene-based (BCB) resin, poly(p-phenylene oxide) (PPO) resin, and mixtures thereof.

In this connection, it is to be understood that the resin composition (RC) comprising the hydrocarbon resin composition (HRC) and at least one di- or polyfuncational resin (B) is a blend.

Any suitable epoxy resin, oxetan resin, bismaleimide resin, cyanate ester resin, diene resin bisbenzocyclobutene-based (BCB) resin and/or poly(p-phenylene oxide) (PPO) resin may be applied.

In one embodiment, the epoxy resin is selected from the group consisting of epoxy resins of formula (IIa), epoxy resins of formula (IIb), epoxy resins of formula (IIc) and oligomeric mixtures thereof, epoxy resins of formula (IId), epoxy resins of formula (IIe), epoxy resins of formula (IIf), epoxy resins of formula (IIg), epoxy resin of formula (IIh), and naphthalenediol diglycidyl ethers;

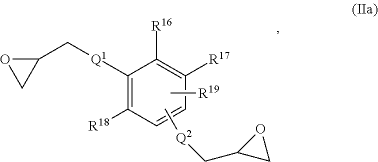

wherein Q¹ and Q² are independently oxygen or —N(G)- with G=oxiranylmethyl, and R¹⁶ through R¹⁹ are independently selected from the group consisting of hydrogen, linear C1-C10-alkyl, linear C1-C10-haloalkyl, branched C4-C10-alkyl, branched C4-C10-haloalkyl, C3-C8-cycloalkyl, halogenated C3-C8-cycloalkyl, C1-C10-alkoxy, halogen, phenyl and phenoxy;

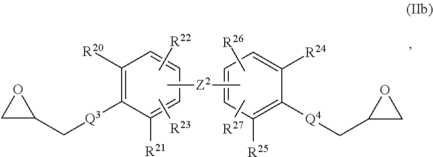

wherein Q³ and Q⁴ are independently oxygen or —N(G)- with G=oxiranyl-methyl, R²⁰ through R²⁷ are independently selected from the group consisting of hydrogen, linear C1-C10-alkyl, linear C1-C10-haloalkyl, branched C4-C10-alkyl, branched C4-C10-haloalkyl, C3-C8-cycloalkyl, halogenated C3-C8-cycloalkyl, C1-C10-alkoxy, halogen, phenyl and phenoxy, and Z² indicates a direct bond or a divalent moiety selected from the group consisting of —O—, —S—, —S(═O)—, —S(═O)₂—, —CH(CF₃)—, —C(CF₃)₂—, —C(═O)—, —C(═CH₂)—, —C(═CCl₂)—, —Si(CH₃)₂—, linear C1-C10-alkanediyl, branched C4-C10-alkanediyl, C3-C8-cycloalkanediyl, 1,2-phenylene, 1,3-phenylene, 1,4-phenylene, glycidyloxyphenylmethylene and —N(R²⁸)— wherein R²⁸ is selected from the group consisting of hydrogen, linear C1-C10-alkyl, linear C1-C10-haloalkyl, branched C4-C10-alkyl, branched C4-C10-haloalkyl, C3-C8-cycloalkyl, phenyl and phenoxy; and

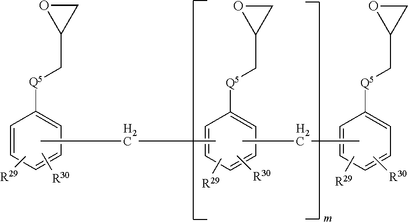

wherein m is an integer from 1 to 20, Q⁵ is oxygen or —N(G)- with G=oxiranylmethyl, and R²⁹ and R³⁰ are independently selected from the group consisting of hydrogen, linear C1-C10-alkyl and branched C4-C10-alkyl;

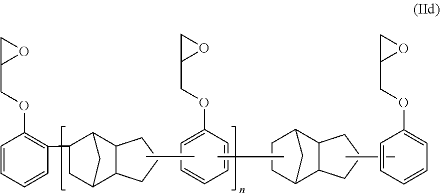

wherein n is 0 or an integer of 1 to 20; and oligomers, prepolymers, polymers or mixtures thereof;

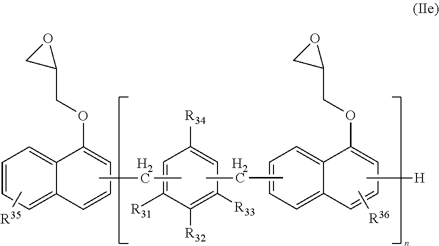

wherein n is an integer of 1 to 20; and R³¹ to R³⁶ are identical or different and independently from each other selected from the group consisting of hydrogen, linear C1-C10-alkyl, branched C3-C10-alkyl, linear C2-C10-alkenyl, and branched C3-C10-alkenyl; and oligomers, prepolymers, polymers or mixtures thereof;

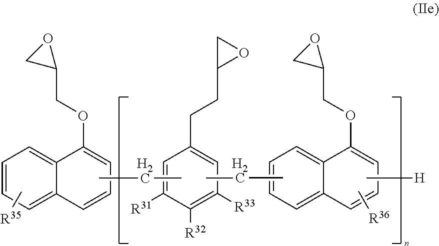

wherein n is an integer of 1 to 20; and R³¹ to R³³, R³⁵, and R³⁶ are identical or different and independently from each other selected from the group consisting of hydrogen, linear C1-C10-alkyl, branched C3-C10-alkyl, linear C2-C10-alkenyl, and branched C3-C10-alkenyl; and oligomers, prepolymers, polymers or mixtures thereof;

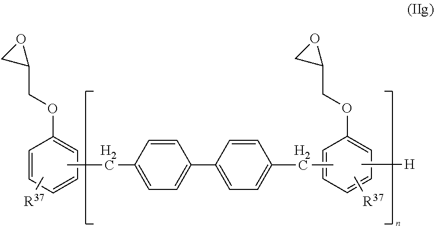

wherein n is an integer of 1 to 20; and R³⁷ is selected from the group consisting of hydrogen, linear C1-C10-alkyl, branched C3-C10-alkyl, linear C2-C10-alkenyl, and branched C3-C10-alkenyl; and oligomers, prepolymers, polymers or mixtures thereof;

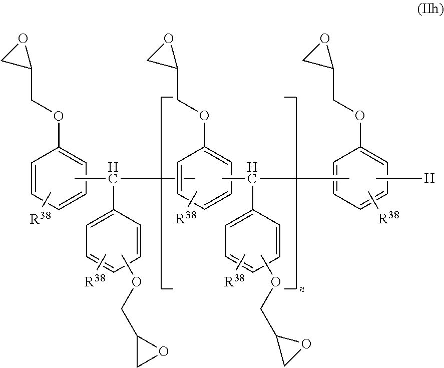

wherein n is 0 or an integer of 1 to 20; and R³⁸ is selected from the group consisting of hydrogen, linear C1-C10-alkyl, branched C3-C10-alkyl, linear C2-C10-alkenyl, and branched C3-C10-alkenyl; and oligomers, prepolymers, polymers or mixtures thereof.

In one embodiment, the epoxy resin is selected from the group consisting of bisphenol A diglycidyl ether resins, bisphenol F diglycidyl ether resins, N, N, O-triglycidyl-3-aminophenol, N, N, O-triglycidyl-4 aminophenol, N,N,N′,N′ tetraglycidyl-4,4′-methylenebisbenzenamine, 4,4′,4″ meth-ylidene-trisphenol triglycidyl ether resins, naphthalenediol diglycidyl ethers, and mixtures thereof.

In one embodiment, the epoxy resin comprises at least one of the following:

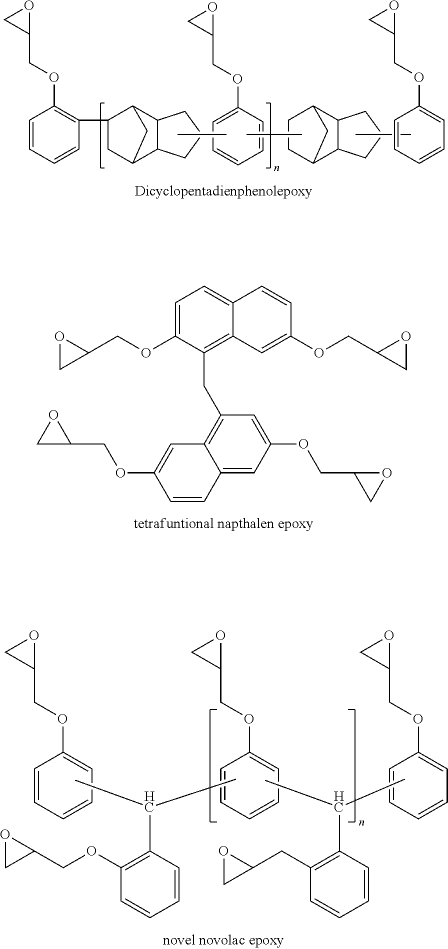

wherein n is 0 or an integer of 1 to 20.

In one embodiment, the bismaleimide resin is selected from the group consisting of bismaleimide resins of formula (IIIa), bismaleimide resins of formula (IIIb), bismaleimide resins of formula (IIIc), bismaleimide resins of formula (IIId), and substituted bisimide of formula (IIIe)

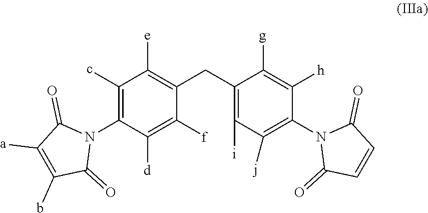

wherein a to j are identical or different and independently from each other selected from the group consisting of hydrogen, halogen, linear C1-C10-alkyl, branched C3-C10-alkyl, linear C2-C10-alkenyl, and branched C3-C10-alkenyl; and oligomers, prepolymers, polymers or mixtures thereof;

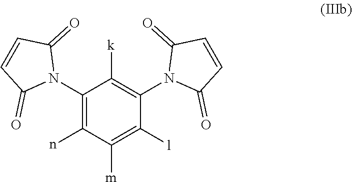

wherein k to m are identical or different and independently from each other selected from the group consisting of hydrogen, halogen, linear C1-C10-alkyl, branched C3-C10-alkyl, linear C2-C10-alkenyl, and branched C3-C10-alkenyl; and oligomers, prepolymers, polymers or mixtures thereof;

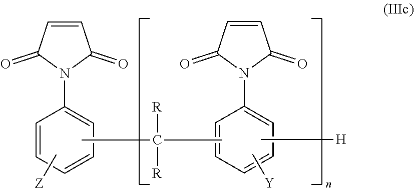

wherein n is an integer of 1 to 20, R, Z, and Y are identical or different and independently from each other selected from the group consisting of hydrogen, halogen, linear C1-C10-alkyl, branched C3-C10-alkyl, linear C2-C10-alkenyl, and branched C3-C10-alkenyl; and oligomers, prepolymers, polymers or mixtures thereof;

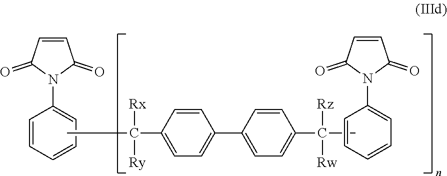

wherein n is an integer of 1 to 20, Rx, Ry, Rz, and R^{w} are identical or different and independently from each other selected from the group consisting of hydrogen, halogen, linear C1-C10-alkyl, branched C3-C10-alkyl, linear C2-C10-alkenyl, and branched C3-C10-alkenyl; and oligomers, prepolymers, polymers or mixtures thereof;

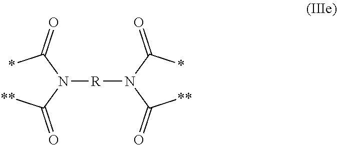

wherein * and ** each denote a covalent bond to the respective C atom denoted with * and ** of a residue,
wherein the residues are identical or different and independently selected from

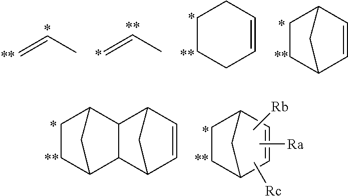

and wherein
R is alkylene, bivalent cycloalkyl, bivalent alkyne, bivalent aryl, bivalent aralkyl, bivalent alkaryl, or bivalent bisaralkyl,
Ra to Rc are independently selected from the group consisting of hydrogen, linear C1-C10-alkyl, linear C1-C10-haloalkyl, branched C4-C10-alkyl, branched C4-C10-haloalkyl, C3-C8-cycloalkyl, halogenated C3-C8-cycloalkyl, linear C2-C10-alkenyl, branched C3-C10-alkenyl, C1-C10-alkoxy, halogen, phenyl and phenoxy,
or Ra and Rb, Ra and Rc, or Rb and Rc may together form a 3 to 8 membered cycloalkyl or a 3 to 8 membered cycloalkenyl; and oligomers, prepolymers, polymers or mixtures thereof.

In one embodiment, the bismaleimide resin comprises at least:

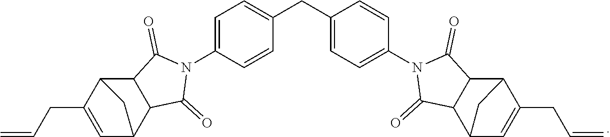 [SMILES: C=CCC1=CC2CC1C1C(=O)N(c3ccc(Cc4ccc(N5C(=O)C6C7C=C(CC=C)C(C7)C6C5=O)cc4)cc3)C(=O)C21]

In one embodiment, the cyanate ester resin is selected from the group consisting of difunctional cyanate ester compounds of formula (Ia), polyfunctional cyanate esters of formula (Ib), polyfunctional cyanate esters of formula (Ic), polyfunctional cyanate esters of formula (Id), polyfunctional cyanate esters of formula (Ie), polyfunctional cyanate esters of formula (If), and mixture thereof

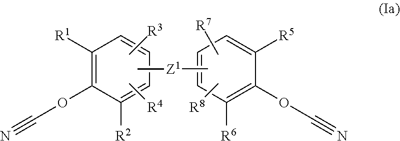

wherein
R¹ through R⁸ are independently selected from the group consisting of hydrogen, linear C1-C10-alkyl, linear C1-C10-haloalkyl, branched C4-C10-alkyl, branched C4-C10-haloalkyl, C3-C8-cycloalkyl, halogenated C3-C8-cycloalkyl, linear C2-C10-alkenyl, branched C3-C10-alkenyl, C1-C10-alkoxy, halogen, phenyl and phenoxy;
wherein at least one of R¹ to R⁸ is selected from the group consisting of linear C2-C10-alkenyl and branched C3-C10-alkenyl;
Z¹ indicates a direct bond or a divalent moiety selected from the group consisting of —O—, —S—, —S(═O)—, —S(═O)₂—, —CH₂—, —CH(CH₃)—, —C(CH₃)₂—, —CH (CF₃)—, —C(CF₃)₂—, —C(═O)—, —C(═CH₂)—, —C(═CCl₂)—, —Si (CH₃)₂—, linear C1-C10-alkanediyl, branched C4-C10-alkanediyl, C3-C8-cycloalkanediyl, 1,2-phenylene, 1,3-phenylene, 1,4-phenylene, —N(R¹³)— wherein R¹³ is selected from the group consisting of hydrogen, linear C1-C10-alkyl, linear C1-C10-haloalkyl, branched C4-C10-alkyl, branched C4-C10-haloalkyl, C3-C8-cycloalkyl, phenyl and phenoxy, and moieties of formulas

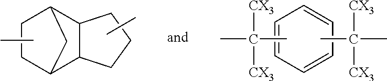

wherein X is independently selected from hydrogen and halogen; and oligomers, prepolymers, polymers or mixtures thereof;

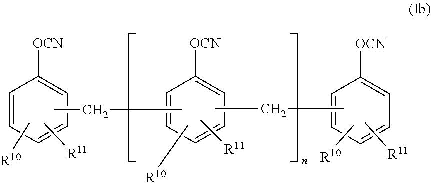

wherein
n is an integer from 1 to 20; and R¹⁰ and R¹¹ are identical or different and independently from each other selected from the group consisting of hydrogen, linear C1-C10-alkyl, branched C4-C10-alkyl, linear C2-C10-alkenyl, and branched C3-C10-alkenyl; and oligomers, prepolymers, polymers or mixtures thereof;

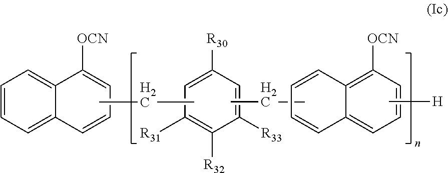

wherein
n is an integer from 1 to 20; and R³⁰, R³¹, R³² and R³³ are identical or different and independently from each other selected from the group consisting of hydrogen, linear C1-C10-alkyl, branched C3-C10-alkyl, linear C2-C10-alkenyl, and branched C3-C10-alkenyl; and oligomers, prepolymers, polymers or mixtures thereof;

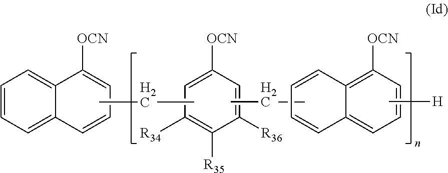

wherein
n is an integer from 1 to 20; and R³⁴, R³⁵ and R³⁶ are identical or different and independently from each other selected from the group consisting of hydrogen, linear C1-C10-alkyl, branched C3-C10-alkyl, linear C2-C10-alkenyl, and branched C3-C10-alkenyl; and oligomers, prepolymers, polymers or mixtures thereof;

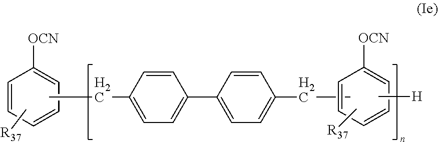

wherein
n is an integer from 1 to 20; and R³⁷ is selected from the group consisting of hydrogen, linear C1-C10-alkyl, branched C3-C10-alkyl, linear C2-C10-alkenyl, and branched C3-C10-alkenyl; and oligomers, prepolymers, polymers or mixtures thereof;

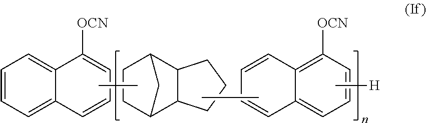

wherein
n is an integer from 1 to 20; and oligomers, prepolymers, polymers or mixtures thereof.

In one embodiment, the diene resin are selected from the group consisting of butadiene homopolymers, butadiene styrene copolymers, maleinized polybutadienes, and mixtures thereof.

In one embodiment, the butadiene homopolymers have a formula (IVa), the butadiene styrene copolymers have a formula (IVb), and the maleinized polybutadienes have a formula (IVc) and/or (IVd)

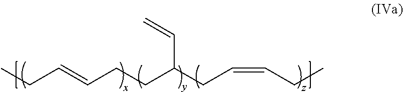

wherein
x, y, and z are identical or different and independently 0 or an integer of 1 to 500, wherein the sum of x+y+z is at least 10;

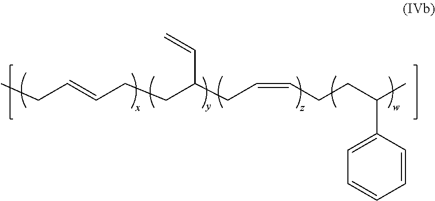

wherein
x, y, z, and w are identical or different and independently 0 or an integer of 1 to 500, wherein the sum of x+y+z+w is at least 10;

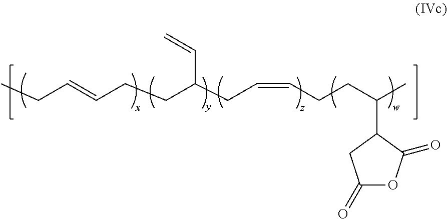

wherein
x, y, z, and w are identical or different and independently 0 or an integer of 1 to 500, wherein the sum of x+y+z+w is at least 10

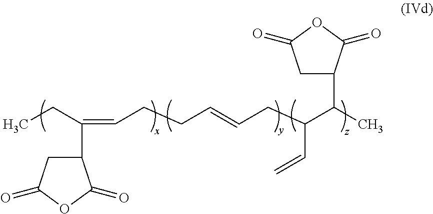

wherein
x, y, z, and w are identical or different and independently 0 or an integer of 1 to 500, wherein the sum of x+y+z+w is at least 10.

In one embodiment the poly(p-phenylene oxide) (PPO) resin is an end group functionalized PPO resin.

In one embodiment the poly(p-phenylene oxide) (PPO) resin is a polyphenylene oxide resin having a structure represented by formula (V):

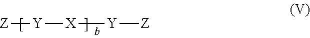

wherein b is a positive integer, X is selected from any one of formula (VI) to formula (VIII) and a combination thereof:

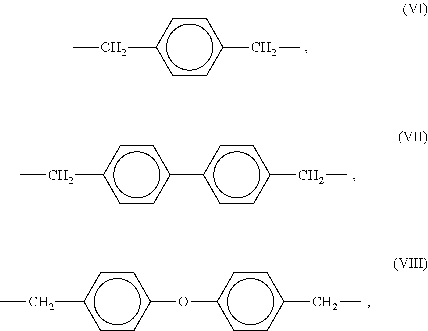

Y has a structure represented by formula (IX):

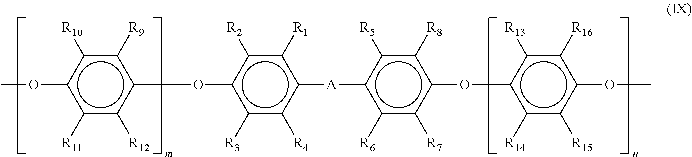

wherein m and n independently represent a positive integer of 1 to 30; R₁ to R₁₆ are independently selected from H, —CH₃ and halogen atoms; A is selected from a covalent bond, —CH₂—, —CH(CH₃)—, —C(CH₃)₂—, —O—, —S—, —SO₂ and carbonyl group, preferably selected from CH₂—, —CH(CH₃)—, —C(CH₃)₂—, —O—, —S—, —SO₂ and carbonyl group;

and Z has a structure of formula (X), (XI) or (XII) or a combination thereof, preferably has a structure of formula (X) or (XII) or a combination thereof:

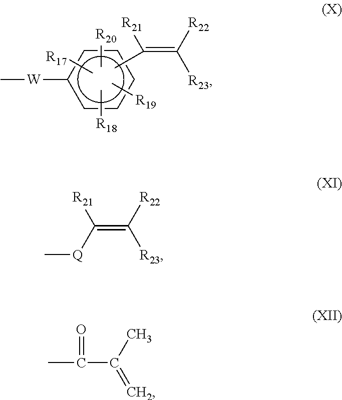

wherein R₁₇ to R₂₃ are independently selected from H, —CH₃ and halogen atoms, and Q and W are independently an aliphatic group.

Suitable poly(p-phenylene oxide) (PPO) resin are SA-90: dihydroxyl-teiminated polyphenylene oxide, available from SABIC; SA-9000: methacrylate-terminated bisphenol A polyphenylene oxide resin, available from SABIC; and OPE-2st: bis(vinylbenzyl)-terminated polyphenylene oxide resin, available from Mitsubishi Gas Chemical Co., Inc.

In one embodiment, the resin composition (RC) comprises at least two di- or polyfunctional resin (B), i.e. a di- or polyfunctional resin (B1) and a di- or polyfunctional resin (B2) being different to the di- or polyfunctional resin (B1), e.g, wherein (B1) is an epoxy resin and (B2) is a bismaleimide resin. It is however also possible that (B1) and (B2) possess similar functionalities but e.g. differ in the substitution patterns and/or molecular weight, i.e. that (B1) and (B2) are both e.g. different epoxy resins. If the resin composition (RC) comprises at least two di- or polyfunctional resin (B), (B1) and (B2) are preferably present in the resin composition (RC) in a weight ratio of about 100:1 to about 1:100, preferably of about 50:1 to about 1:50 such as of about 10:1 to about 1:5, or of about 8:1 to about 1:1, or of about 6:1 to about 3:1.

In one embodiment, the resin composition (RC) comprises
a) about 9.99 to about 99.99 wt %, preferably about 9.9 to about 99.9 wt %, more preferably about 19.5 to about 96.5 wt %, and in particular about 50 to 9 about 1, of the hydrocarbon resin composition (HRC);
b) about 0 to about 90 wt %, preferably about 0 to about 85 wt %, more preferably about 3 to about 80 wt %, and in particular about 8 to about 49 wt %, of the at least one di- or polyfunctional resin (B); and
c) about 0.01 to about 25 wt %, preferably about 0.1 to about 20 wt %, more preferably about 0.5 to about 15 wt %, and in particular about 1 to about 6 wt %, of the catalyst (C), each wt % based on the total weight of the resin composition (RC), preferably based on the total dry weight of the resin composition (RC).

In one embodiment, the resin composition (RC) comprises
a) about 80.9 to about 99.9 wt %, preferably about 90.5 to about 99.5 wt %, and in particular about 95 to about 91, of the hydrocarbon resin composition (HRC); and
c) about 0.1 to about 19.1 wt %, preferably about 0.5 to about 9.5 wt %, and in particular about 1 to about 5 wt %, of the catalyst (C), each wt % based on the total weight of the resin composition (RC), preferably based on the total dry weight of the resin composition (RC).

In one embodiment, the resin composition (RC) comprise at least 25 wt % such as at least 30 wt %, or at least 35 wt %, or at least 40 wt %, or at least 45 wt %, or at least 50 wt %, or at least 60 wt %, or at least 65 wt %, or at least 70 wt %, or at least 75 wt %, or at least 80 wt %, or at least 85 wt %, or at least 90 wt %, or at least 95 wt %, of the hydrocarbon resin composition (HRC), based on the total weight of the resin composition (RC). In one embodiment, the resin composition (RC) comprises up to 99.9 wt % such as up to 98 wt %, or up to 95 wt %, or up to 90 wt %, or up to 85 wt %, or up to 80 wt %, or up to 75 wt %, or up to 70 wt %, or up to 65 wt %, or up to 60 wt %, or up to 55 wt %, or up to 50 wt %, of the hydrocarbon resin composition (HRC), based on the total weight of the resin composition (RC).

In one embodiment, the catalyst (C) is present in the resin composition (RC) of about 0.1 to about 20 wt %, preferably of about 0.3 to about 15 wt % such as of about 0.5 to about 10 wt %, or of about 1 to about 6 wt %, or of about 1 to about 4 wt %, based on the total weight of the hydrocarbon resin composition (HRC).

In one embodiment the hydrocarbon resin composition (HRC) and the at least one di- or polyfunctional resin (B) have a weight ratio of about 99:1 to about 10:90, preferably of about 95:5 to about 20:80 such as of about 92:8 to about 40:60, or of about 90:10 to about 60:30.

In one embodiment, the catalyst is selected from the group consisting of radical initiators and Lewis acid catalysts.

In one embodiment, the catalyst is a photo initiator, preferably selected from the group consisting of radical initiator, Lewis acid catalyst, and mixtures thereof.

As an example of the catalyst that can be used, it is preferable to use a radical initiator for the purpose of promoting self-polymerization of a radically polymerizable curable resin such as an olefin compound or a maleimide resin, or radical polymerization with other components. Examples of the radical initiators that can be used include, but are not limited to, known curing accelerators: ketone peroxides such as methyl ethyl ketone peroxide and acetylacetone peroxide; diacyl peroxides such as benzoyl peroxide; dialkyl peroxides such as dicumyl peroxide and 1,3-bis(t-butylperoxyisopropyl)-benzene; peroxyketals such as t-butylperoxybenzoate and 1,1-di-t-butylperoxycyclohexane; alkyl peresters such as a-cumylperoxyneodecanoate, t-butylperoxyneodecanoate, t-butylperoxypivalate, 1,1,3,3-tetramethylbutylperoxy-2-ethylhexanoate, t-mylperoxy-2-ethylhexanoate, t-butylperoxy-2-ethylhexanoate, t-amylperoxy-3,5,5-trimethylhexanoate, t-butylperoxy-3,5,5-trimethylhexanoate and t-amylperoxybenzoate; peroxycarbonates such as di-2-ethylhexylperoxydicarbonate, bis(4-t-butylcyclohexyl) peroxydicarbonate, t-butylperoxyisopropyl carbonate and 1,6-bis(t-butylperoxycarbonyloxy) hexane; organic peroxides such as t-butyl hydroperoxide, cumene hydroperoxide, t-butylperoxyoctoate, and lauroyl peroxide; and azo compounds such as azobisisobutyronitrile, 4,4′-azobis(4-cyanovaleric acid) and 2,2′-azobis(2,4-dimethylvaleronitrile). The ketone peroxides, diacyl peroxides, hydroperoxides, dialkyl peroxides, peroxyketals, alkyl peresters, percarbonates, and the like are preferred, and the dialkyl peroxides are more preferred. The addition amount of the radical initiator is preferably 0.01 to 5 parts by mass, and particularly preferably 0.01 to 3 parts by mass, based on 100 parts by mass of the resin composition. When the amount of the radical initiator used is large, the molecular weight does not sufficiently extend during the polymerization reaction.

In one embodiment, the radical initiator is selected from the group consisting of dialkyl peroxide, diacyl peroxide, azo compound, and mixtures thereof and/or the Lewis acid catalysts is selected from the group consisting of a cationic thermal acid generator, a cationic photo-acid generator, and mixtures thereof.

Suitable Lewis acid catalysts include but are not limited to cationic thermal acid generators, cationic photo-acid generators, or other Lewis acid catalysts, including but not limited to transition metal complexes, boron compounds, aluminum compounds, titanium compounds, or tin compounds.

Other suitable Lewis acid catalysts include boron compounds, aluminum compounds, titanium compounds, tin compounds and compounds of transition metals known in the art. Particularly suitable Lewis acid initiators include bis(4-dodecylphenyl) iodonium hexafluoroantimonate such as SpeedCure 937 available from Arkema, bis-(4-t-butylphenyl)-iodonium hexafluorophosphate such as SpeedCure 938 available from Arkema, 4-isopropyl-4′-methyldiphenyliodonium tetrakis(pentafluorophenyl) borate such as SpeedCure 939 available from Arkema, and (sulfanediy Idibenzene-4,1-diyl)bis(dipheny Isulfonium) bis(hexafluoroantimonate) such as 5 SpeedCure 976s available from Arkema and stannous octoate such as Reaxis C129 available from Reaxis. Lewis acid initiators may be added at any level suitable to effect sufficient polymerization, ranging from ppm levels to 5 wt %, depending on the initiator used. Lewis acid initiators may be combined with other Lewis acid initiators or other classes of suitable catalysts as desired to affect the polymerization.

Suitable radical initiators include but are not limited to dialkyl peroxides, diacyl peroxides, and azo compounds. Particularly suitable radical initiators include dicumyl peroxide and 2,5-Dimethyl-2,5-di-(tert-butylperoxy) hexyne-3 (Trigonox 145-E85). Radical initiators may be added at any level suitable to effect sufficient polymerization, ranging from ppm levels to 5 wt % depending on initiator used. Radical initiators may be combined with other radical initiators or other classes of suitable catalysts as desired to affect the polymerization.

Cationic thermal acid generators and photo-acid generators produce strong acids upon activation at elevated temperature or upon absorption of specific energy wavelengths. Suitable cationic thermal acid generators and photo-acid generators include onium salts such as iodonium and sulfonium salts. Suitable catalysts include but are not limited to diaryliodonium compounds or triarylsulfonium compounds paired with anions such as BF4-, B(C6F5)4-, PF6-, AsF6-, SbF6- and variations thereof.

In one embodiment, the catalyst is selected from the group consisting of camphor quinone; benzophenone, benzophenone derivatives, such as 2,4,6-trimethylbenzophenone, 2-methylbenzophenone, 3-methylbenzo-phenone, 4-methylbenzophenone, 2-methoxycarbonylbenzophenone 4,4′-bis(chloromethyl)-benzophenone, 4-chlorobenzophenone, 4-phenylbenzophenone, 3,3 ‘-dimethyl-4-methoxy-benzophenone, [4-(4-methylphenylthio)phenyl]-phenylmethanone, methyl-2-benzoyl-benzoate, 3-methyl-4’-phenylbenzophenone, 2,4,6-trimethyl-4′-phenylbenzophenone, 4,4 ‘-bis(dimethylamino)benzophenone, 4,4’-bis(diethylamino)benzophenone; thioxanthones, thioxanthone derivatives, polymeric thio-xanthones as for example OMNIPOL TX; ketal compounds, as for example benzyldimethyl-ketal (IRGACURE® 651); acetophenone, acetophenone derivatives, for example a-hydroxy-cycloalkyl phenyl ketones or a-hydroxyalkyl phenyl ketones, such as for example 2-hydroxy-2-methyl-1-phenyl-propanone (DAROCUR® 1173), 1-hydroxy-cyclohexyl-phenyl-ketone (IRGACURE® 184), 1-(4-dodecylbenzoyl)-1-hydroxy-I-methyl-ethane, 1-(4-isopropylbenzoyl)-1-hydroxy-1-methyl-ethane, 1-[4-(2-hydroxyethoxy)-phenyl]-2-hydroxy-2-methyl-1-propan-1-one (IRGACURE®2959); 2-hydroxy-1-{4-[4-(2-hydroxy-2-methyl-propionyl)-benzyl]-phenyl}-2-methyl-propan-1-one (IRGACURE® 127); 2-hydroxy-1-{4-[4-(2-hydroxy-2-methyl-propionyl)-phenoxy]-phenyl}-2-methyl-propan-1-one; dialkoxyacetophenones, α-hydroxy- or α-am-inoacetophenones, e.g., (4-methylthiobenzoyl)-1-methyl-1-morpholinoethane (IRGACURE® 907), (4-morpholinobenzoyl)-1-benzyl-1-dimethylaminopropane (IRGACURE® 369), (4-morpholinobenzoyl)-1-(4-methylbenzyl)-1-dimethylaminopropane (IRGACURE® 379), (4-(2-hydroxyethyl)aminobenzoyl)-1-benzyl-1-dimethylaminopropane), (3,4-dimethoxybenzoyl)-1-benzyl-1-dimethyl aminopropane; 4-aroyl-1,3-dioxolanes, benzoin alkyl ethers and benzyl ketals, e.g. dimethyl benzyl ketal, phenylglyoxalic esters and derivatives thereof, e.g., methyl a-oxo benzeneacetate, oxo-phenyl-acetic acid 2-(2-hydroxy-ethoxy)-ethyl ester, dimeric phenylglyoxalic esters, e.g. oxo-phenyl-acetic acid 1-methyl-2-[2-(2-oxo-2-phenyl-acetoxy)-propoxy]-ethyl ester (IRGACURE® 754); ketosulfones, e.g. ESACURE KIP 1001 M®; oxime-esters, e.g., 1,2-octanedione 1-[4-(phenylthio)phenyl]-2-(0-benzoyloxime) (IRGACURE® OXEOI), ethanone I-[9-ethyl-6-(2-methylbenzoyl)-9H-carbazol-3-yl]-I-(O-acetyloxime) (IRGACURE® OXE02), 9H-thioxanthene-2-carboxaldehyde 9-oxo-2-(0-acetyloxime), peresters, benzophenone tetracarboxylic peresters, monoacyl phosphine oxides, e.g. (2,4,6-trimethylbenzoyl)diphenylphosphine oxide (DAROCUR® TPO), ethyl (2,4,6 trimethylbenzoyl phenyl)phosphinic acid ester; bisacyl-phosphine oxides, e.g., bis(2,6-dimethoxy-benzoyl)-(2,4,4-trimethyl-pentyl)phosphine oxide, bis(2,4,6-trimethylbenzoyl)-phenylphosphine oxide (IRGACURE® 819), bis(2,4,6-trimethyl-benzoyl)-2,4-dipentoxyphenylphosphine oxide, trisacylphosphine oxides, halomethyltriazines, e.g., 2-[2-(4-methoxy-phenyl)-vinyl]-4,6-bis-trichloromethyl-[1,3,5]triazine, 2-(4-methoxy-phenyl)-4,6-bis-trichloromethyl-[1,3,5]triazine, 2-(3,4-dimethoxy-phenyl)-4,6-bis-trichlorome-thyl-[1,3,5]triazine, 2-methyl-4,6-bis-trichloromethyl-[1,3,5]triazine, hexaarylbisimidazole/co-initiators systems, e.g., ortho-chlorohexaphenyl-bisimidazole combined with 2-mercapto-benzthiazole, ferrocenium compounds, titanocenes, e.g., bis(cyclopentadienyl)-bis(2,6-difluoro-3-pyrryl-phenyl) titanium (IRGACURE®784), bis(2,4,6-trimethylbenzoyl)-phenylphosphineoxide, bis-(4-dodecylphenyl) iodonium hexafluroantimonate in glycidyl ether, (sulfanediyldibenzene-4,1-diyl)bis(diphenylsulfonium) bis(hexafluoroantimonate) in digycidyl ether, ethyl phenyl(2,4,6-trimethylbenzoyl)phosphinate, low viscosity monofunctional oxetane, 1,4-bis[(3-ethyl-3-oxetanylmethoxy)methyl]benzene, 7-oxabicyclo[4.1.0]hept-3-ylmethyl 7-oxabicyclo[4.1.0]heptane-3-carboxylate, and mixtures thereof.

In one embodiment, the resin composition further comprises a sensitizer such as isopropyl-9H-thioxanthen-9-on (including mixtures of 2— and 4-isomer of Isopropyl-9H-thioxanthen-9-on).

In one embodiment, the resin composition (RC) is a liquid mixture.

In one embodiment, the resin composition (RC) has at 25 °C a viscosity of less than about 10,000 mPa×s, preferably of less than about 5,000 mPa×s, more preferably of less than about 1,000 mPa×s, and in particular of less than about 600 mPa×s. Alternatively, it is preferred that the resin composition (RC) has at 25 °C a viscosity of about 5 to about 10,000 mPa×s, more preferably of about 10 to about 5,000 mPa×s, still more preferably of about 20 to about 1,000 mPa×s, and in particular of about 50 to about 500 mPa×s. In general, the viscosity of the resins may be determined by a Brookfield LV viscometer equipped with a themosel unit.

In one embodiment, the resin composition (RC) has at 80 °C a viscosity of less than about 5,000 mPa×s, preferably of less than about 1,000 mPa×s, more preferably of less than about 800 mPa×s, and in particular of less than about 300 mPa×s. Alternatively, it is preferred that the resin composition (RC) has at 80 °C a viscosity of about 0.1 to about 5,000 mPa×s, more preferably of about 0.5 to about 1,000 mPa×s, still more preferably of about 1 to about 800 mPa×s, and in particular of about 2 to about 300 mPa×s.

In one embodiment, the resin composition (RC) further comprises additional components selected from the group consisting of (internal) mold release agents, fillers, reactive diluents, and mixtures thereof.

Internal mold release agents are preferably present in amounts of 0 to 5 wt %, based on the total amount of components (HRC), (B), and (C). Examples of suitable internal mold release agents to be added to the resin composition (RC) (e.g. being a liquid mixture) obtained in step (i) are Axel XP I PHPUL-1 (a proprietary synergistic blend of organic fatty acids, esters and amine neutralizing agent) and Axel MoldWiz® INT-1850HT (a proprietary synergistic blend of organic fatty acids, esters and alkanes and alkanols, supplier: Axel Plastics Research Laboratories, Inc., Woodside NY, USA). Other mold release agents are usually rubbed on a mold surface. Examples of those mold release agents are Frekote® 700-NC (a mixture of hydrotreated heavy naphtha (60-100%), dibutyl ether (10-30%), naphtha (petroleum) light alkylate (1-5%), octane (1-5%) and proprietary resin (1-5%); supplier: Henkel AG & Co. KGaA, Düsseldorf, Germany) or Chemlease R&B EZ (a mixture of hydrocarbon C7-C9 isoalkanes (50-700%), alkanes C9-12-iso (10-20%), low boiling point naphtha (5-10%), hydrocarbon isoalkanes (1-2.5%) supplier: Chem-trend Maisach-Gernlinden Germany).

Fillers are preferably present in amounts of 0 to 40 wt %, based on the total amount of components (HRC), (B), and (C). They may be in particle, powder, sphere, chip and/or strand form in sized from nano scale to millimeters. Suitable fillers may be organic, such as thermoplastics and elastomers, or inorganic, such as glass microspheres, graphite, or silica; and mineral powders, preferably CaCO₃, coated CaCO₃, kaolin clay, SiO₂ (e.g. sand), talc, graphite, corundum (α-Al₂O₃), wollastonite, SiC, glass microspheres, mica, calcium silicate (Ca₂O₄Si), MgO, anhydrous calcium sulfate (CaSO₄ or anhydrite), ceramic hollow microspheres, fused mullite (Al₂O₃—SiO₂), boron nitride (BN), vermiculite, or basalt; and mixtures thereof.

Reactive diluents are preferably present in amounts of 0 to 20 wt %, based on the amount of component (B). Examples of suitable reactive diluents are liquid mono-, di- or trifunctional epoxy compounds derived from aliphatic or cycloaliphatic alcohols or phenols, such as diglycidyl ethers of glycols, in particular 1,w alkanediols having 4 to 12 carbon atoms, for example 1,4-(diglycidyloxy) butane or 1,12-(diglycidyloxy)-dodecane, or the diglycidyl ether of neopentyl glycol, glycidyl ethers of linear or branched primary alcohols having 8 to 16 carbon atoms, for example 2 ethylhexyl glycidyl ether or C8-C16 alkyl glycidyl ether, or the diglycidyl ether of 1,4-cyclohexanedimethanol.

In one embodiment the resin composition (RC), e.g. the liquid mixture, provided in step (i) contains little or no additional (non-reactive) solvent such as acetone or butanone. Preferably, it contains less than 20 wt %, more preferably less than 15 wt %, even more preferably less than 10 wt % or 5 wt %, each percentage being based on the total weight of components (HRC), (B), and (C), or, most preferably, no solvent at all.

In one embodiment, the fiber structure provided in step (ii) is selected from the group consisting of carbon fibers, glass fibers (e.g. E glass fibres or S glass fibres), quartz fibers, boron fibers, ceramic fibers, aramid fibers (including KEVLAR®), polyester fibers, polyethylene fibers, natural fibers (e.g. flax, hemp, jute or sisal), and mixtures thereof.

In one embodiment, the fiber structure provided in step (ii) is selected from the group consisting of strands, yarns, rovings, unidirectional fabrics, 0/90° fabrics, woven fabrics (multi-layered or single layered), hybrid fabrics, multiaxial fabrics, chopped strand mats, tissues, braids, and combinations thereof.

The fiber structure may be pre-shaped fibers. The fiber structure may be chopped or continuous, random or oriented, woven or non-woven, knitted or non-knitted or braided according to the requirements of any of various different portions of the desired structure of the fiber-reinforced part.

The amount of fiber structure may vary depending on the desired need of the fiber-reinforced part. Fiber structure content in the fiber composition (FC) or in the fiber-reinforced part typically is in the range of up to 60 or even up to 95 wt % of the total weight of the fiber composition (FC) or the fiber-reinforced part, respectively, in another embodiment, the content of the fiber structure may vary from 0.1 to 60 or even to 80 wt % or 95 wt %, or from 1 to 60 or even to 80 wt % or 95 wt %, or from 5 to 60 or even to 80 wt % or 95 wt %, or from 10 to 60 or even to 80 wt % or 95 wt %, or from 20 wt % to 60 or even to 80 wt % or 95 wt %, of the total weight of the fiber composition (FC) or the fiber-reinforced part, respectively.

In one embodiment, the method further comprises the addition of flame retardants.

Suitable flame retardants may be aluminium trihydroxide (ATH), phosphorus-containing compounds and compounds as defined by formula (F),

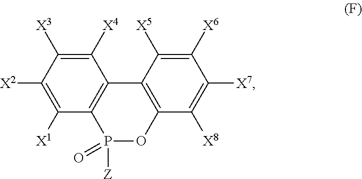

wherein
X¹ to X⁸ are independently hydrogen, alkyl, cycloalkly, aryl, or aralkyl, and
Z is a group represented by the general formula (F1) or by the general formula (F2)

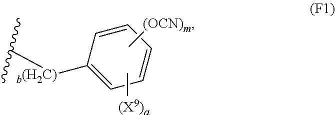

wherein
X⁹ is independently hydrogen, alkly, cycloalkly, aryl, or aralkyl, and
a is an integer of 1 to 4, b is 0 or an integer of 1 to 4, and m is an integer of 1 to 4, or a group;

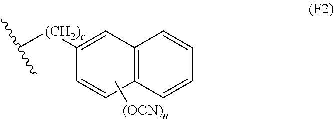

wherein
c is 0 or an integer of 1 to 4, and n is an integer of 1 to 3.

The phosphorus-containing compound may be a reactive compound or an addition-type compound. Specific examples of the phosphorus-containing compound include: phosphoric acid esters such as trimethyl phosphate, triethyl phosphate, tricresyl phosphate, trixylylenyl phosphate, cresyl diphenyl phosphate, cresy 1-2,6-dixylylenyl phosphate, 1,3-phenylene bis(dixylylenyl phosphate), 1,4-phenylene bis(dixylylenyl phosphate), and 4,4′-biphenyl(dixylylenyl phosphate); phosphanes such as 9,10-dihydro-9-oxa-10-phosphaphenanthrene-10-oxide and 10-(2,5-dihydroxyphenyl)-10H-9-oxa-10-phosphaphenanthrene-10-oxide; phosphorus-containing epoxy compounds obtained by allowing an epoxy resin to react with active hydrogens of the phosphanes; and red phosphorus. The phosphoric acid esters, the phosphanes, and the phosphorus-containing epoxy compounds are preferred, and 1,3-phenylenebis(dixylylenyl phosphate), 1,4-phenylene bis(dixylylenyl phosphate), 4,4′-biphenyl(dixylylenyl phosphate), or the phosphorus-containing epoxy compounds are particularly preferred. The content of the phosphorus-containing compound (phosphorus-containing compound)/(total epoxy resin) is preferably within a range of 0.1 to 0.6 (weight ratio).

Suitable phosphorus-containing compound are depicted in the following:

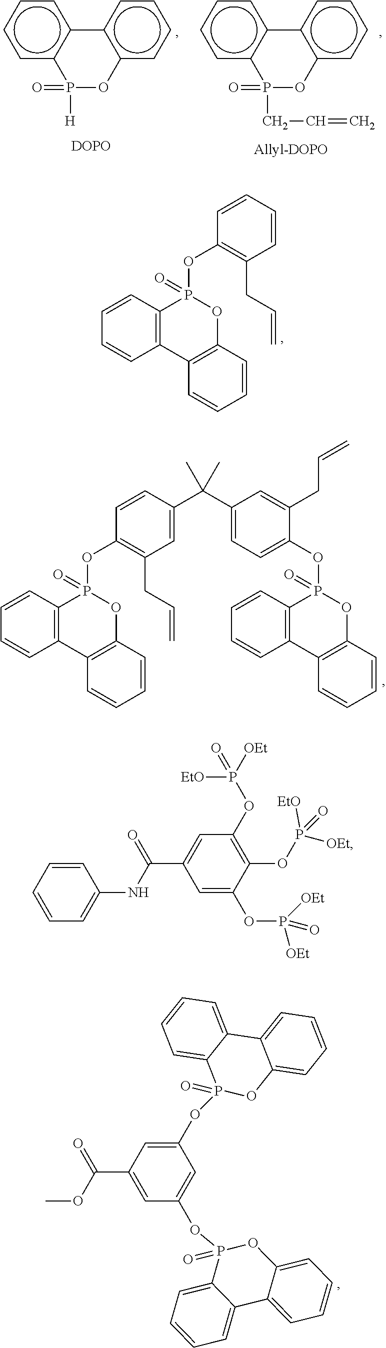

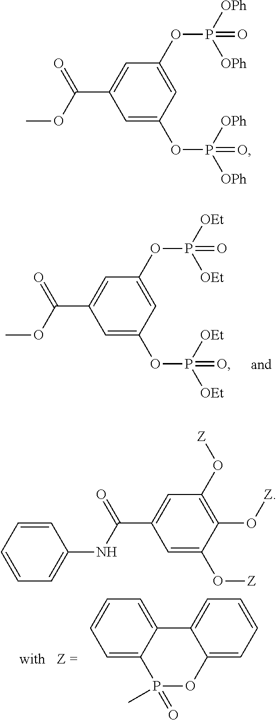

As aforementioned, the present invention relates in a second aspect to a fiber-reinforced part obtainable by the method as above-outlined in more detail.

Particular embodiments (e.g. regarding the ingredients, amounts, moieties, method details such as time and temperature) are already above-outlined in connection with the inventive method and shall hold for the fiber-reinforced part, as well. In the following, particular embodiments of the fiber-reinforced part are described in further detail. It is to be understood that each embodiment is relevant on its own as well as in combination with other embodiments.

The T_{g} glass transition temperature can be measured by any known in the art method such as Thermal Mechanical Analysis (TMA). A suitable machine used is a Mettler Toledo instrument TMA SDTA840.

In one embodiment, the fiber-reinforced part exhibits a high-temperature resistance, as given by the Tg value (determined by Tg onset via TMA measurement) of preferably more than 100 °C, more preferably more than about 110 °C, and in particular more than about 120 °C, after step (iv). In a preferred embodiment, the fiber-reinforced part exhibits a Tg value (determined by Tg onset via TMA measurement) of about 100 to about 220 °C; preferably of about 110 to about 200 °C, and in particular of about 120 to about 160 °C, after step (iv).

In one embodiment, the fiber-reinforced part exhibits a Tg (determined by Tg onset via TMA measurement) of more than about 170 °C, preferably of more than about 180 °C, and in particular of more than 200 °C, after step (v). In a preferred embodiment, the fiber-reinforced part exhibits a Tg value (determined by Tg onset via TMA measurement) of about 170 to about 400 °C; preferably of about 180 to about 350 °C, and in particular of about 190 to about 300 °C, after step (v).

In a preferred embodiment, the fiber-reinforced part are obtained by the method as above-outlined in more detail.

As aforementioned, the present invention relates in a third aspect to the use of the fiber-reinforced part as above-outlined in more detail in visible or non-visible applications.

Particular embodiments (e.g. regarding the ingredients, amounts, moieties, method details such as time and temperature, and Tg) are already above-outlined in connection with the inventive method and fiber-reinforced parts and shall hold for the use, as well. In the following, particular embodiments of the use are described in further detail. It is to be understood that each embodiment is relevant on its own as well as in combination with other embodiments.

In one embodiment, the visible or non-visible applications include (but are not limited to), fiber reinforced panels, such as protective covers, door and flooring panels, doors, stiffeners, spoilers, diffusors, boxes, etc., complex geometries, such as molded parts with ribs, parts with rotational symmetry parts such as pipes, cylinders, and tanks, in particular fuel tanks, oil and gas riser, exhaust pipes, etc., and massive or hollow profiles, such as stiffeners, spring leaves, carriers, etc., and sandwich-structured parts with or without core structure, such as blades, wings, etc., carbon fiber-reinforced plastic molds for the manufacture of high performance composite materials, or electronic applications, such as printed circuit board, prepreg, or laminates, radome or reentry space shields, satellites.

As aforementioned, the present invention relates in a fourth aspect to a visible or non-visible application comprising a fiber-reinforced parts as above-outlined in more detail.

Particular embodiments (e.g. regarding the ingredients, amounts, moieties, method details such as time and temperature, Tg) are already above-outlined in connection with the inventive method and fiber-reinforced parts and shall hold for the visible or non-visible applications, as well. In the following, particular embodiments of the visible or non-visible applications are described in further detail. It is to be understood that each embodiment is relevant on its own as well as in combination with other embodiments.

In one embodiment, the visible or non-visible application include (but are not limited to), fiber reinforced panels, such as protective covers, door and flooring panels, doors, stiffeners, spoilers, diffusors, boxes, etc., complex geometries, such as molded parts with ribs, parts with rotational symmetry parts such as pipes, cylinders, and tanks, in particular fuel tanks, oil and gas riser, exhaust pipes, etc., and massive or hollow profiles, such as stiffeners, spring leaves, carriers, etc., and sandwich-structured parts with or without core structure, such as blades, wings, etc., carbon fiber-reinforced plastic molds for the manufacture of high performance composite materials, or electronic applications, such as printed circuit board, prepreg, or laminates, radome or reentry space shields, satellites.

As aforementioned, the present invention relates in a fifth aspect to a kit comprising
1) a container (A) comprising
a resin composition (RC) comprising
a.1) a hydrocarbon resin composition (HRC) derived from a hydrocarbon resin having a structure as defined by formula (A3)

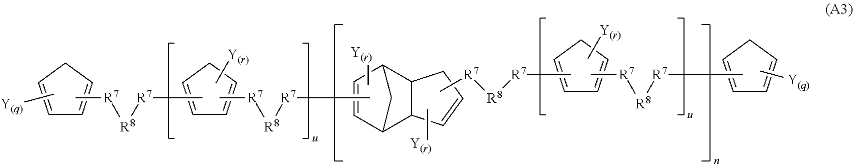

wherein
R⁷ is independently a methylene group (CH₂) or a methylene group substituted with one or more —CH₃ or halogen functionalities;
R⁸ is independently a bond or a straight-chain or branched, linear or cyclic, saturated or unsaturated, substituted or unsubstituted, aliphatic or aromatic group having between 1 and 20 carbon atoms,
Y is independently a functionality possessing at least one non-aromatic alkene, alkyne, C1-C13-alkyl, or an aromatic moiety;
q is an integer of 1 to 5;
r is independently 0 or an integer of 1 to 4,
u is independently 0, or an integer greater than or equal to 1, when u is 0, the bracket region represents a bond, and
n is 0 or an integer greater than or equal to 1, when n is 0, the bracket region represents a bond;
2) optionally a container (B) comprising at least one di- or polyfunctional resin (B); and
3) optionally a container (C);
wherein the kit further comprises a catalyst (C), which is comprised in container (A), container (B), and/or container (C).

The kit can be used in a method for preparing fiber-reinforced parts.

Particular embodiments (e.g. regarding the ingredients, amounts, moieties, method details such as time and temperature, Tg) are already above-outlined in connection with the inventive method and fiber-reinforced parts and shall hold for the kit, as well. In the following, particular embodiments of the kit are described in further detail. It is to be understood that each embodiment is relevant on its own as well as in combination with other embodiments.

In one embodiment, the kit comprises the container (B).

It will be obvious for a person skilled in the art that these embodiments and items only depict examples of a plurality of possibilities. Hence, the embodiments shown here should not be understood to form a limitation of these features and configurations. Any possible combination and configuration of the described features can be chosen according to the scope of the invention.

The present invention will be further illustrated by the following examples.

### EXAMPLES

### Methods

### Resin Transfer Molding (RTM)/Resin Injection

The process Resin Transfer Molding is described: The fiber reinforcement (i.e. fiber structure) is placed in a mold set; the mold is closed and clamped. The resin is injected into the mold cavity under pressure. The motive force in RTM is pressure. Therefore, the pressure in the mold cavity will be higher than atmospheric pressure. In contrast, vacuum infusion methods use vacuum as the motive force, and the pressure in the mold cavity is lower than atmospheric pressure.

The resin injection molding process is designed for high output (short cycle time) part manufacturing under repetitive conditions, with very limited tolerances (concerning all process parameters, e.g. such as viscosity, mix ratio, permeability of the reinforcement, geltime, cycle time). It is most commonly used to process both thermoplastic and thermosetting polymers.

### Desired Characteristic of the Resin Used in RTM:

Must have a low viscosity at a certain temperature as it is held in the reservoir prior to injection
Must impregnate the fiber preform quickly and uniformly without voids.
Must gel as quickly as possible once impregnation occurs (fast cycle time).
Must possess sufficient hardness to be demolded without distortion
Low viscosity critical (<1000 mPa×s at impregnation temperature to impregnate preform loading of 50%)
Low viscosity requires less pressure to achieve adequate fiber wetting.
Injection temperature (typically elevated) of resin should be held as close as possible to minimum viscosity to ensure preform impregnation, since higher temperatures accelerate curing, thus cutting injection time.

The resin compositions developed (Cyclopentadiens/and its blends) can be also applied in composite manufacturing processes with dynamically changing mold temperatures, e.g. such as the Quickstep or Roctool processes.

### Technical Characteristic:

Cyclopentadiens/and its blend resin systems could be cured with the catalyst in RTM resin injection processes. The cure time could be designed varying the catalyst amount (for example from 0.5 to 5 wt % or more) which depend e.g. by the injection temperature and mold temperature applied for the process. Finally, the cure cycle time could be reduced to values in the order of 5-30 minutes, preferably 5-20 minutes. Post-cure treatment between 180 °C and 300 °C, preferably between 180 °C and 230 °C, was applied in order to achieve the desired high thermal and mechanical performance.

### Material

### HC-100 Synthetic Procedure

2000 ml toluene, 326 g 1,4-bis(chloromethyl)benzene and 68.9 g methyltributylammonium chloride was charged to a reactor and the suspension was cooled to about 8 °C. 625 g cyclopentadiene and 902 g potassium hydroxide (50% aq. solution) was added while maintaining the temperature between about 8 to 13 °C. Additional 4017 g potassium hydroxide (50% aq. solution) was dosed at the same temperature range. The reaction mixture was heated to about 20 °C and 430 g allyl chloride and 230 g benzyl chloride was added by parallel dosage at a temperature between about 20 and 25 °C followed by the addition of 181 g 1,2-dichloroethane at the same temperature range. After complete addition, the reaction mixture was heated to about 50 °C and stirred at this temperature for about 1 h.

The mixture was heated to 70 °C for 1 h and washed with water twice. Then the solvent was removed by distillation (30 mbar/70 °C) to isolate the final product in a yield of 80%.

### HC-200 Synthetic Procedure

150 ml HC-100 was heated to 150 °C for ~3-7 h for prepolymerization. The prepolymerization was stopped, if resin viscosity reached ~100-500 mPa*s @ 82 °C.

### BCMB-164 Synthetic Procedure

1483 ml toluene, 404 g 4,4′-bis(chloromethyl)-1,1′-biphenyl and 61 g methyltributylammonium chloride was charged to a reactor and the suspension was cooled to about 8 °C. 600 g cyclopentadiene and 795 g potassium hydroxide (50% aq. solution) was added while maintaining the temperature between about 8 to 13 °C. Additional 3539 g potassium hydroxide (50% aq. solution) was dosed at the same temperature range. The reaction mixture was heated to about 20 °C and 377 g allyl chloride and 206 g benzyl chloride was added by parallel dosage at a temperature between about 20 and 25 °C followed by the addition of 159 g 1,2-dichloroethane at the same temperature range. After complete addition, the reaction mixture was heated to about 50 °C and stirred at this temperature for about 1 h.

The mixture was heated to 70 °C for 1 h and washed with water twice. Then the solvent was removed by distillation (30 mbar/70 °C) to isolate the final product in a yield of 64%.

### PXDC:BCMB(1:1)-170 Synthetic Procedure

1267 ml toluene, 123 g 1,4-bis(chloromethyl)benzene, 173 g 4,4′-bis(chloromethyl)-1,1′-biphenyl and 52 g methyltributylammonium chloride was charged to a reactor and the suspension was cooled to about 8 °C. 500 g cyclopentadiene and 679 g potassium hydroxide (50% aq. solution) was added while maintaining the temperature between about 8 to 13 °C. Additional 3025 g potassium hydroxide (50% aq. solution) was dosed at the same temperature range. The reaction mixture was heated to about 20 °C and 322 g allyl chloride and 176 g benzyl chloride was added by parallel dosage at a temperature between about 20 and 25 °C followed by the addition of 136 g 1,2-dichloroethane at the same temperature range. After complete addition, the reaction mixture was heated to about 50 °C and stirred at this temperature for about 1 h.

The mixture was heated to 70 °C for 1 h and washed with water twice. Then the solvent was removed by distillation (30 mbar/70 °C) to isolate the final product in a yield of 84%.

### TFB—(174) Synthetic Procedure

451 ml toluene, 1242 g 1,4-bis(bromomethyl)-2,3,5,6-tetrafluorobenzene and 51 g methyltributylammonium chloride was charged to a reactor and the suspension was cooled to about 8 °C. 450 g cyclopentadiene and 665 g potassium hydroxide (50% aq. solution) was added while maintaining the temperature between about 8 to 13 °C. Additional 2961 g potassium hydroxide (50% aq. solution) was dosed at the same temperature range. The reaction mixture was heated to about 20 °C and 315 g allyl chloride and 172 g benzyl chloride was added by parallel dosage at a temperature between about 20 and 25 °C followed by the addition of 133 g 1,2-dichloroethane at the same temperature range. After complete addition, the reaction mixture was heated to about 50 °C and stirred at this temperature for about 1 h.

The mixture was heated to 70 °C for 1 h and washed with water twice. Then the solvent was removed by distillation (30 mbar/70 °C) to isolate the final product in a yield of 47%.

BCMB-164, PXDC: BCMB (1:1)-170 and TFB-(174) can be prepolymerized in a similar was than HC-100.

Ricon 100 (copolymer of butadiene and styrene), Ricon 130 (homopolymer of polybutadiene), Ricon 138 (homopolymer of polybutadiene), Ricon 152 (homopolymer of polybutadiene, Dry Liquid 70% Active), Ricon 153 (homopolymer of polybutadiene, Dry Liquid 65% Active), Ricon 156 (homopolymer of polybutadiene), Ricon 157 (homopolymer of polybutadiene), Ricon 181 (butadiene-styrene copolymer), Ricon 300 (liquid polybutadiene resin) are available from Cray Valley

BMI-/Derivatives: Homide 100 (Bisallylnadic imide P, CAS-No. 91865-54-2), Homide 126A (4,4′-Diallylether bisphenol A, CAS-No. 3739-67-1), Homide 127A (2,2′-Diallyl bisphenol A (DABA), CAS-No. 1745-89-7) and Homide 400 (Resin based on Biscitraconimide) are available form HOS Technik

BMI-5100 (3,3′-dimethyl-5,5′-diethyl-4,4′-diphenylmethane bismaleimide, CAS NO: 105391-33-1) is available from Dawei Kasei

Additional BMI may be selected from Homide 250 (bismaleimide resin, CAS-no. 26140-67-0), Homide 123 (Homide 123, CAS-No. 6422-83-9), Homide 121 (4,4′-Diphenylmethane-bismaleimide, CAS-No. 13676-54-5), and 2300 (phenylmethane maleimide, CAS NO: 67784-74-1).

BMPI-300 having the structure

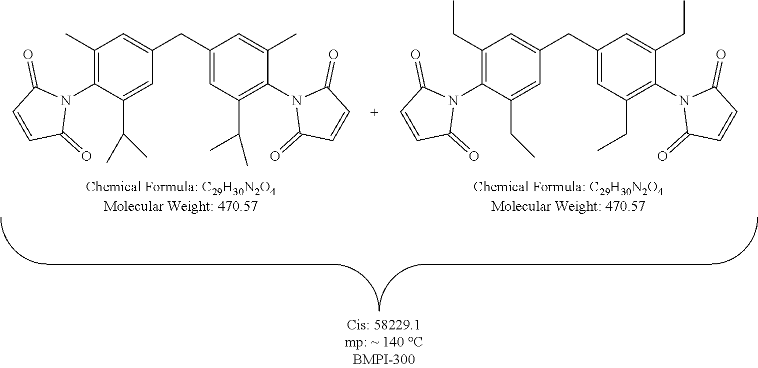 [SMILES: Cc1cc(Cc2cc(C)c(N3C(=O)C=CC3=O)c(C(C)C)c2)cc(C(C)C)c1N1C(=O)C=CC1=O ; CCc1cc(Cc2cc(CC)c(N3C(=O)C=CC3=O)c(CC)c2)cc(CC)c1N1C(=O)C=CC1=O]

& DETDA-BMI having the structure

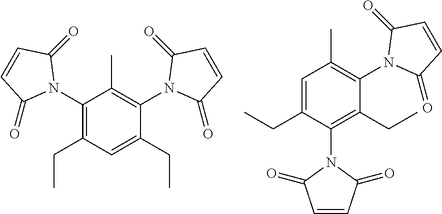

are available from Arxada

Epoxies: HP-7250 (Modified-Novolac type epoxide), HP-7200 (dicyclopentadiene type epoxide) and HP4710 (naphthalene type epoxide) are available from DIC Corporation

Epoxy: Epikote 828 (a medium viscosity liquid epoxy resin produced from bisphenol A resin and epichlorohydrin) is available form Westlake (former Hexion)

Cyanate Ester: DT-4000 (cyanate ester resin; further synonyms are polyphenolcyanate and triazine polymer), LECY (cyanate ester resin; further synonyms are 4,4′-ethylidendiphenyldicyanat, 1,1-bis(4-cyanatophenyl) ethan, bisphenol-E-dicyanate), PT-30 (cyanate ester resin; further synonyms are phenolic novolac cyanate ester resin, polyphenolcyanate, triazine polymer), CL-100 (crosslinking material which combines cyanate ester functionalities and reactive double bonds) are all available from Arxada

HTM-100 BT-Resin (bismaleimide triazine) available from Arxada

Catalyst: Speedcure 937 (bis-(4-dodecylphenyl) iodonium hexafluroantimonate in glycidyl ether), available from Arkema

Additional catalysts may be selected from 938 (bis-(4-t-butylphenyl)-iodonium hexafluorophosphate) and 939 (4-isopropyl-4′-methyldiphenyliodonium tetrakis(pentafluorophenyl) borate)

SA-9000 (polyphenylene oxide (PPO) telechelic copolymers) are available from Sabic

Addolink 1604 (isobutyl 3,5-diamino-4-chlorobenzoate) was obtained from Lanxess

Lonzacure® M-DEA (4,4′-methylenebis-(2,6-diethyl)-aniline) was obtained from Arxada

Divinylbenzol (DVB) is available from Aldrich and was used without further purification

All other chemicals/regents were obtained from Sigma Aldrich and used without any further purification

### Example 1

Primaset® HC-100 (150 g) was mixed at room temperature with the liquid catalyst Speedcure 937 (4.5 g). The mixing can be done at room temperature using Speedmixer for 2 minutes at 2000 RPM or by mechanical stirring for 5-10 min till full homogenization.

The viscosity of the resin system is shown in Table 1 below:

TABLE 1
Viscosity of HC-100 Cyclopentadien Resin

| Temperature [°C] | Viscosity [mPa × s] |
|---|---|
| 25 | 250 |
| 80 | 10 |

The low viscosity and high fiber wetting potential of the resin system can provide good processability parameters. The resin can be injected at temperatures between 25 °C and 80 °C with viscosities below 500 mPa×s.

The resin system must gel as quickly as possible once the impregnation is completed. The gelation time can be controlled by varying the amount of catalyst and the temperature as shown in Table 2 below. The amount of catalyst is given in percent by weight, based on the amount of cyclopentadien resin.

TABLE 2
Gel Time (Gelnorm) of Cyclopentadien with catalyst

| Catalyst | | | | | |
|---|---|---|---|---|---|
| Speedcure 937 ™ | Gel Time (Gelnorm) [min] | | | | |
| (%) | 60 °C | 80 °C | 100 °C | 120 °C | 140 °C |
| 1 | n.d. | n.d. | 100-120 | 20-30 | n.d. |
| 3 | n.d. | n.d. | 70-85 | 10-15 | n.d. |

(n.d.: not determined)

By setting a mold temperature, for example of, 100-150 °C, the resin system containing 2 to 3 wt. % catalyst achieved sufficient hardness within 30 min to allow demolding without distortion. Glass or carbon fiber composite parts could be produced by this method. A summary of the technical parameters is shown in Table 3 below.

TABLE 3
Summary of Technical Parameters for RTM-Resin Injection:

| Parameters | Values | |
|---|---|---|
| Resin 1 (Primaset ™ HC-100) | 150 | g |
| Catalyst (Speedcure 937) | 2-3 wt. % to the resin | |
| Fiber type | Glass or carbon fibers | |
| Injection temperature | 25-80 | °C |
| Viscosity at infusion temperature (25 °C) | <500 | mPa × s |
| Mold temperature | 120-150 | °C |

| | |
|---|---|
| Mold cure cycle | 20-240 min @ 120-150 °C |

High temperature resistance (respectively a high T_{g}) can be achieved either through a defined post-cure process step in an oven (temperature between 180 °C and 230 °C) or during service in a high temperature environment.

The viscosity of the resins is determined by a Brookfield LV viscometer equipped with a themosel unit.

The T_{g} glass transition temperature was measured by Thermal Mechanical Analysis (TMA). The machine used was a Mettler Toledo instrument TMA SDTA840. The T_{g} was evaluated on the second ramp. The results are shown in Table 4 below.

TABLE 4
Thermal Performance (Example 1)

| | |
|---|---|
| Cure cycle | 30 min @ 150 °C + Demold |
| Post cure cycle | 25-230 °C @ 1 K/min + 1 h @ 230 °C |
| T_{g} onset by TMA | >230 °C |

### Example 2

### Vacuum Assisted Resin Transfer Molding (VAR™) and Resin Infusion:

### Technical Characteristic:

A flat glass mold was used. The mold was cleaned, and the surface was rubbed with a mold release agent. In this test, the liquid release agent Chemlease R&B EZ from Chem-trend Maisach-Gernlinden Germany was used.

The carbon fiber fabric was cut into 25×25 cm² pieces and care was taken to prevent fiber pullout during handling of the cut plies. 16 plies were cut for each of the experimental laminates. In the test case, the carbon fabric fibers used were Toho Tenax HTA40 E13 (supplier: Toho Tenax Europe GmbH, Wuppertal, Germany). Then the carbon fiber fabric layers prepared were laid on the mold surface. Care was taken to build up a symmetric lay-up in order to prevent distortion during the post-cure stage.

In this example, an Airtech Omega Flow Line was used for both the resin feed and the vacuum line. The dimension of the Omega Flow Line was the same as the width of the carbon fiber layers on both sides (resin feed inlet and vacuum line outlet). Once the resin was infiltrated on one side, the resin feed line was filled on its complete length very quickly. After that, the resin infused across the whole carbon laminate lay-up toward the vacuum outlet.

The following resin infusion auxiliary materials were utilized: An “all-in-one” peel ply and release film layer (Fibertex Compoflex® SB150) was cut and placed directly in contact over the carbon fiber layers. A resin distribution medium layer (Airtech Knitflow 105 HT) was cut and installed on the top of the previous layup (carbon fibers and peel ply/release film layers). The resin distribution medium allowed the spreading of the resin quickly in the whole composite part. The distribution layer was positioned as well as a basement of the Omega Flow Line (Airtech Omega Flow Lines OF750) for the resin feed inlet. On the other side of the mold (vacuum line outlet), a resin distribution layer and a Compoflex® SB150 (Fibertex Nonwovens A/S, Aalborg, Denmark) layer were placed as a basement for the Omega Flow Line. All layers of material in contact with the mold were compressed to avoid “bridging” when vacuum was applied. High temperature resin infusion connectors (Airtech VAC-RIC-HT or RIC-HT) were attached to the middle of the resin feed inlet and vacuum outlet channels.

A customized rectangular vacuum bag was used which was heat seamed at three sides of its perimeter and specially designed for the mold dimension (Airtech Wrightlon® WL5400 or WL7400). All the infusion assembly was set up inside the vacuum bag which was finally heat seamed on the one open side of its perimeter. Two small holes were punctured in the bag. The feed line and vacuum line connectors were attached to the bag over the holes and nylon tubes were installed. The assembled mold was connected with a resin source and a vacuum pump.

The whole mold assembly was installed inside an oven to infuse at the required temperature. Full vacuum and temperature was applied to the bag assembly for 3 up to 12 hours before infusion was started. It was beneficial to apply to the fiber lay-up and mold assembly the processing temperature conditions in order to improve the flow process and to remove the moisture picked-up from the fiber layers.

The vacuum pump was turned-on with a vacuum of 3-5 mbar, and excellent sealing was achieved by checking leakages.

### Example A

116.5 g of the Primaset™ HC-100 was mixed at 25 °C with 3.88 g of Speedcure 937 catalyst (3 wt % to the resin). The resin+catalyst system was mixed using a Speedmixer equipment at 2000 rpm for one minute till complete homogenization.

The vacuum bag pressure was set to 10 mbar. The resin system viscosity was lower than 500 mPa×s and the Primaset™ HC-100+catalyst could be successfully infused at room temperature with speed of 0.30 cm/min and made to flow through the fibers under the bag.

The full vacuum of 10 hPa was kept till the resin reached cure point. The material was cured under the bagging assembly using the following cure cycle:

25 °C-115 °C, 1 K/min; 1h @ 115 °C+ramp 1 °C/min to 150 °C+5.5 h @ 150 °C+cooling down

After curing the material could be easily demolded from the bagging assembly. A post cure cycle can be applied as follows, in order to reach the mechanical and thermal performances desired: 25 °C-230 °C, 0.5 K/min, 2 h @ 220 °C.

The Tg glass transition temperature was measured by Thermal Mechanical Analysis (TMA) as described in Example 1. The result is shown in Table 5 below:

TABLE 5
Thermal Properties (Example 2-A)

| | |
|---|---|
| Post cure cycle | 25-230 °C @ 0.5 K/min + 2 h @ 230 °C |
| T_{g} onset by TMA | >230 °C |

### Example B

116.5 g of the Primaset™ HC-200 prepolymer of HC-100 was heated at 80 °C to reduce its viscosity. Then 3.88 g of Speedcure 937 catalyst (3 wt % to the resin) was added at 80 °C and the resin+catalyst system was mixed with speedmixer at 2000 rpm for one minute till complete homogenization.

The vacuum bag pressure was set to 10 mbar. The Primaset™ HC-200+catalyst could be successfully infused at 80 °C in an oven with speed of 1.2 cm/min and made to flow through the fibers under the bag.

The full vacuum of 10 mbar was kept till the resin reached cure point. The material was cured in an oven under the bagging assembly using the following cure cycle:

80-100 °C ramp 1 °C/min, 2h @ 100 °C, 100-120 °C. 1 °C/min, 2 h 120 °C, 120-150 °C ramp 1 °C/min, 2h @ 150 °C+cooling down

After curing the material could be easily demolded from the bagging assembly. A post cure cycle can be applied as follows, in order to reach the mechanical and thermal performances desired: 25 °C-230 °C, 1 °C/min, 2 h @ 230 °C.

The Tg glass transition temperature was measured by Thermal Mechanical Analysis (TMA) as described in Example 1. The result is shown in Table 6 below:

TABLE 6
Thermal Properties (Example 2-B)

| | |
|---|---|
| Post cure cycle | 25-230 °C @ 0.5 K/min + 2 h @ 230 °C |
| T_{g} onset by TMA | >230 °C |

### Example 3

### Filament Winding:

### Technical Characteristic:

A cylindrical mandrel was used to form a composite pipe with an inner diameter of 40 mm. The mandrel was cleaned, and the surface was rubbed with a mold release agent.

The fiber reinforcement (carbon fiber Toho Tenax HTA (supplier: Toho Tenax Europe GmbH, Wuppertal, Germany)) was formed by 4 rovings. The fibers were directly pulled from the bobbin through the resin bath, which was kept at a constant temperature of 40 °C. The impregnated fibers were placed on the mandrel in different angles of +30° and 89° to form 18 layers, resulting in a pipe wall thickness of 4.4 mm.

The mandrel and the impregnated fibers placed hereon were kept at a constant temperature of 50 °C.

Primaset™ HC-100 Resin was mixed with the catalyst Speedcure 937 (2 wt %) at 50 °C until complete homogenization. The resin+catalyst system was placed into the resin bath at 50 °C. Then the filament winding process started as described. Once the filament winding process is completed, the part with the mandrel is cured as following:

80-100 °C ramp 1 °C/min, 2h @ 100 °C, 100-120 °C. 1 °C/min, 2 h 120 °C, 120-150 °C ramp 1 °C/min, 2h @ 150 °C+cooling down to ambient temperature (cooling rate 1 K/min), and demolding from the mandrel at ambient.

Finally, the pipe was subjected to a post-cure treatment at 25 °C→230 °C, 1 K/min and 2 h @ 230 °C.

A summary of the technical parameters is shown in Table 7 below.

The T_{g} glass transition temperature was measured by Thermal Mechanical Analysis (TMA) as described in Example 1.

TABLE 7
Thermal Properties (Example 4)

| | |
|---|---|
| Post cure cycle | 25-230 °C @ 1 K/min + 2 h @ 230 °C |
| T_{g} onset by TMA | 200-220 °C |

### Example 4

Similar process and process conditions as in Example 1-3 (regarding the resin composition and curing conditions) were applied to the following mixtures with HC-100, to obtain parts with high Tg and good electrical performance (Dk<3 and Df<0.004 for all examples). The resins HC-200, BCMB-164, PXDC: BCMB (1:1)-170 and TFB-(174) (and analogoues prepolymers) can be applied, as well.

A Split-Cylinder Resonator (SCR) method was used for the electrical performance. The permittivity er and loss tangent tanδ (Dk and Df properties) are obtained and calculate with Agilent E8361A Network Analyzer. The results are according to the standard method IPC™-650 2.5.5.13.

The compositions ingredients and the results are shown in Table 8 below:

TABLE 8
Tg values of parts

| Cyclopentadien | Thermoset | Ratio | Catalyst | Tg |
|---|---|---|---|---|
| resin | resin | [w %] | [w %] | [°C] |
| HC-100 | Ricon 100 | 80:20 | 2-3 | 130/250* |
| HC-100 | Ricon 130 | 80:20 | 2-3 | 100/250* |
| HC-100 | Ricon 138 | 80:20 | 2-3 | 135/250* |
| HC-100 | Ricon 152 | 80:20 | 2-3 | 140/250* |
| HC-100 | Ricon 153 | 80:20 | 2-3 | 115/250* |
| HC-100 | Ricon 156 | 80:20 | 2-3 | 80/250* |
| HC-100 | Ricon 157 | 80:20 | 2-3 | 90/250* |
| HC-100 | Ricon 181 | 80:20 | 2-3 | 150/250* |
| HC-100 | Ricon 300 | 80:20 | 2-3 | 150/250* |
| HC-100 | BMPI-300 | 90:10 | 2-3 | 280 |
| HC-100 | BMPI-300 | 80:20 | 2-3 | 280 |
| HC-100 | BMI-5100 | 90:10 | 2-3 | 280 |
| HC-100 | BMI-5100 | 80:20 | 2-3 | 280 |
| HC-100 | DETDA-BMI | 90:10 | 2-3 | 270 |
| HC-100 | DETDA-BMI | 80:20 | 2-3 | 270 |
| HC-100 | Homide 100 | 90:10 | 2-3 | 270 |
| HC-100 | Homide 100 | 80:20 | 2-3 | 270 |
| HC-100 | Homide 400 | 90:10 | 2-3 | 230 |
| HC-100 | Homide 400 | 80:20 | 2-3 | 230 |
| HC-100 | Homide 126A | 80:20 | 2-3 | 200 |
| HC-100 | HP-7250 | 95:5 | 1-3 | 230 |
| HC-100 | EHP-7250 | 75:25 | 1-3 | 127/245* |
| HC-100 | HP-7200 | 95:5 | 1-3 | 148/240* |
| HC-100 | HP-7200 | 75:25 | 1-3 | 127/245* |
| HC-100 | Epikote 828 | 95:5 | 1-3 | 180/230 |
| HC-100 | Epikote 828 | 75:25 | 1-3 | 200 |
| HC-100 | HP-7250/ | 70:25:5 | 1-3 | 160/245* |
| | Homide127A | | | |
| HC-100 | SA-9000 | 80:20 | 1-3 | 210** |
| HC-100 | LECY | 90:10 | 0-0.5 | 200 |
| HC-100 | LECY | 25:75 | 0-0.5 | 120 |
| HC-100 | HTM-100 | 90:10 | 0-0.5 | 210 |
| HC-100 | PT-30 | 90:10 | 0-0.5 | 220 |
| HC-100 | DT-4000 | 90:10 | 0-0.5 | 170 |
| HC-100 | DT-4000 | 25:75 | 0-0.5 | 150 |
| HC-100 | CL-100 | 90:10 | 0-0.5 | 205 |
| HC-100 | CL-100 | 25:75 | 0-0.5 | 140 |
| HC-100 | DT-4000 | 25:75 | 0-0.5 | 150 |
| HC-100 | DVB | 90:10 | 1-3 | 230 |

Comparative example

| | | | | |
|---|---|---|---|---|
| M-DEA | Epikote 828 | (1:1) Eq | n.a. | 150 |
| Addolink 1604 | Epikote 828 | (1:1) Eq | n.a. | 150 |

*Two Tg's obtained
**Tg determination by sandwich method (sample between two quartz plates)

### Example 5: Thermal Curing of PXDC:BCMB(1:1)—170

| | | |
|---|---|---|
| 53.39 | (PXDC:BCMB(1:1) (batch 170) was combined with | 3.00 |
| 1.65 | Speedcure 937 | 3% |

and mixed in a speedmixer for 1 min at 2000 RPM
The mixture was poured in a round mould (13 × 13 × 0.2 cm) that
was preheated to 100 °C
Cure Cycle:
2 h 100 °C, 100-120 °C, 2 h 120 °C, 120-150 °C, 2 h 150 °C,
150-230 °C, 2 h, open cool down

→ Tg(TMA) = 249 °C

### Example 6: Thermal Curing of TFB—174

| | | |
|---|---|---|
| 53.39 | TFB (batch 174) was combined with | 3.04 |
| 1.65 | Speedcure 937 | 3% |

and mixed in a speedmixer for 1 min at 2000 RPM
The mixture was poured in a round mould (13 × 13 × 0.2 cm) that
was preheated to 100 °C
Cure Cycle:
2 h 100 °C, 100-120 °C, 2 h 120 °C, 120-150 °C, 2 h 150 °C,
150-230 °C, 2 h, open cool down

→ Tg(TMA) = 257 °C

The above component combinations are well mixable and the resin compositions are well workable due to a suitable viscosity. In addition, as can be derived from the above table, the resin compositions provide a high Tg. Thus, the resin compositions are particularly suitable for fiber-reinforced part.

1. A method for preparing a fiber-reinforced part comprising the steps of
(i) providing a resin composition (RC) comprising
a) a hydrocarbon resin composition (HRC) derived from a hydrocarbon resin having a structure as defined by formula (A3) 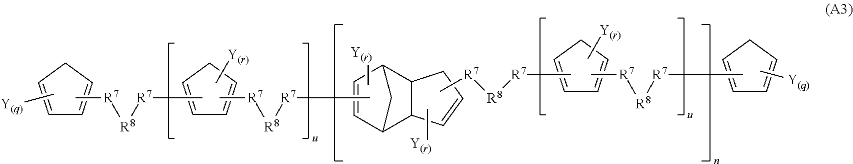
wherein
R⁷ is independently a methylene group (CH₂) or a methylene group substituted with one or more —CH₃ or halogen functionalities;
R⁸ is independently a bond or a straight-chain or branched, linear or cyclic, saturated or unsaturated, substituted or unsubstituted, aliphatic or aromatic group having between 1 and 20 carbon atoms,
Y is independently a functionality possessing at least one non-aromatic alkene, alkyne, C1-C13-alkyl, or an aromatic moiety;
q is an integer of 1 to 5;
r is independently 0 or an integer of 1 to 4,
u is independently 0, or an integer greater than or equal to 1, when u is 0, the bracket region represents a bond, and
n is 0 or an integer greater than or equal to 1, when n is 0, the bracket region represents a bond;
b) optionally at least one di- or polyfunctional resin (B); and
c) a catalyst (C);
(ii) providing a fiber structure;
(iii) contacting said fiber structure with said resin composition (RC) providing a fiber composition (FC); and
(iv) curing said fiber composition (FC).

2. The method according to claim 1, wherein step (ii) further comprises placing said fiber structure in a mold or on a substrate and/or wherein the contacting in step (iii) is an impregnating.

3. The method according to claim 1, wherein
in step (iii) a temperature of about 20 to about 95 °C is applied, preferably at an elevated pressure and/or wherein the air is evacuated; and/or
in step (iv) a temperature of about 30 to about 150 °C is applied.

4. The method according to claim 1, wherein the hydrocarbon resin composition (HRC) comprises at least two of (A1) to (A3)
a.1) a hydrocarbon resin having a structure as defined by formula (A1) 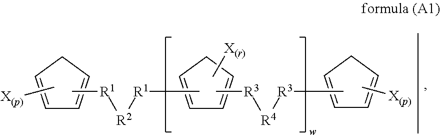
wherein
R¹ is independently a methylene group (CH₂) or a methylene group substituted with one or more —CH₃ or halogen,
R² is a bond or a substituted or unsubstituted C1-C20 alkylene,
R³ is independently a methylene group (CH₂) or a methylene group substituted with one or more —CH₃ or halogen,
R⁴ is independently a bond or a substituted or unsubstituted C1-C20 alkylene, C4-C20 aromatic group, or saturated or unsaturated C4-C20 cyclic group,
X is independently a functionality possessing at least one non-aromatic alkene, alkyne, C1-C13 alkyl, or an aromatic moiety,
p is independently an integer of 1 to 5,
r is independently 0 or an integer of 1 to 4, and
w is 0 or an integer of 1 to 50 and when w is 0, the bracket region represents a bond;
a.2) a hydrocarbon resin having a structure as defined by formula (A2) 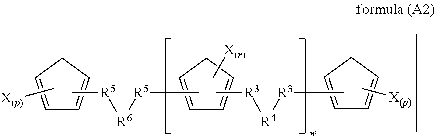
wherein
R³ is independently a methylene group (CH₂) or a methylene group substituted with one or more —CH₃ or halogen,
R⁴ is independently a bond or a substituted or unsubstituted C1-C20 alkylene, C4-C20 aromatic group, or saturated or unsaturated C4-C20 cyclic group,
R⁵ is independently a methylene group (CH₂) or a methylene group substituted with one or more —CH₃ or halogen,
R⁶ is a substituted or unsubstituted C4-C20 aromatic group or saturated or unsaturated C4-C20 cyclic group,
X is independently a functionality possessing at least one non-aromatic alkene, alkyne, C1-C13 alkyl, or an aromatic moiety,
p is independently an integer of 1 to 5,
r is independently 0 or an integer of 1 to 4, and
w is 0 or an integer of 1 to 50 and when wis 0, the bracket region represents a bond; and
a.3) a polymer, prepolymer, or oligomer derived from a hydrocarbon resin having a structure defined by formula (A3) 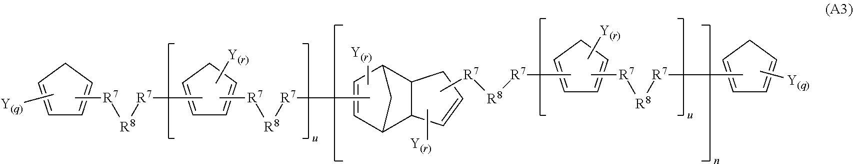
wherein
R⁷ is independently a methylene group (CH₂) or a methylene group substituted with one or more —CH₃ or halogen functionalities,
R⁸ is independently a bond or a straight-chain or branched, linear or cyclic, saturated or unsaturated, substituted or unsubstituted, aliphatic or aromatic group having between 1 and 20 carbon atoms,
Y is independently a functionality possessing at least one non-aromatic alkene, alkyne, C1-C13-alkyl, or an aromatic moiety,
q is an integer of 1 to 5,
r is independently 0 or an integer of 1 to 4,
u is independently 0, or an integer greater than or equal to 1, when u is 0, the bracket region represents a bond, and
n is 0 or an integer greater than or equal to 1, when n is 0, the bracket region represents a bond.

5. The method according to claim 1, wherein the resin composition (RC)
comprises
a) about 9.99 to about 99.99 wt %, preferably about 9.9 to about 99.9 wt %, more preferably about 19.5 to about 96.5 wt %, and in particular about 50 to about 91, of the hydrocarbon resin composition (HRC);
b) about 0 to about 90 wt %, preferably about 0 to about 85 wt %, more preferably about 3 to about 80 wt %, and in particular about 8 to about 49 wt %, of the at least one di- or polyfunctional resin (B); and
c) about 0.01 to about 25 wt %, preferably about 0.1 to about 20 wt %, more preferably about 0.5 to about 15 wt %, and in particular about 1 to about 6 wt %, of the catalyst (C), each wt % based on the total weight of the resin composition (RC).

6. The method according to claim 1, wherein the resin composition (RC) comprises
b) at least one di- or polyfuncational resin (B), preferably selected from the group consisting of epoxy resin, oxetan resin, bismaleimide resin, cyanate ester resin, diene resin, bisbenzocyclobutene-based (BCB) resin, poly(p-phenylene oxide) (PPO) resin, and mixtures thereof.

7. The method according to claim 6, wherein the epoxy resin is selected from the group consisting of epoxy resins of formula (IIa), epoxy resins of formula (IIb), epoxy resins of formula (IIc) and oligomeric mixtures thereof, epoxy resins of formula (IId), epoxy resins of formula (IIe), epoxy resins of formula (IIf), epoxy resins of formula (IIg), epoxy resin of formula (IIh), and naphthalenediol diglycidyl ethers; 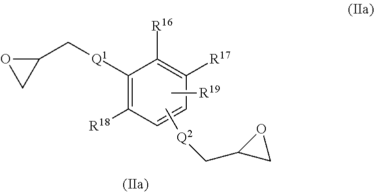
wherein Q¹ and Q² are independently oxygen or —N(G)- with G=oxiranylmethyl, and R¹⁶ through R¹⁹ are independently selected from the group consisting of hydrogen, linear C1-C10-alkyl, linear C1-C10-haloalkyl, branched C4-C10-alkyl, branched C4-C10-haloalkyl, C3-C8-cycloalkyl, halogenated C3-C8-cycloalkyl, C1-C10-alkoxy, halogen, phenyl and phenoxy; 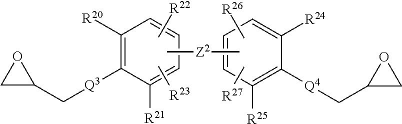
wherein Q³ and Q⁴ are independently oxygen or —N(G)- with G=oxiranyl-methyl, R²⁰ through R²⁷ are independently selected from the group consisting of hydrogen, linear C1-C10-alkyl, linear C1-C10-haloalkyl, branched C4-C10-alkyl, branched C4-C10-haloalkyl, C3-C8-cycloalkyl, halogenated C3-C8-cycloalkyl, C1-C10-alkoxy, halogen, phenyl and phenoxy, and Z² indicates a direct bond or a divalent moiety selected from the group consisting of —O—, —S—, —S(═O)—, —S(═O)₂—, —CH(CF₃)—, —C(CF₃)₂—, —C(═O)—, —C(═CH₂)—, —C(═CCl₂)—, —Si(CH₃)₂—, linear C1-C10-alkanediyl, branched C4-C10-alkanediyl, C3-C8-cycloalkanediyl, 1,2-phenylene, 1,3-phenylene, 1,4-phenylene, glycidyloxyphenylmethylene and —N(R²⁸)— wherein R²⁸ is selected from the group consisting of hydrogen, linear C1-C10-alkyl, linear C1-C10-haloalkyl, branched C4-C10-alkyl, branched C4-C10-haloalkyl, C3-C8-cycloalkyl, phenyl and phenoxy; and 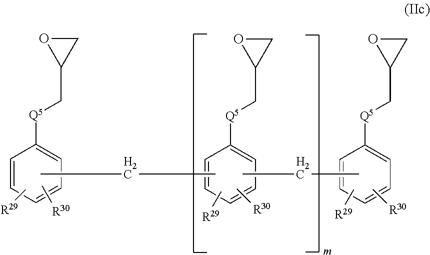
wherein m is an integer from 1 to 20, Q⁵ is oxygen or —N(G)- with G=oxiranylmethyl, and R²⁹ and R³⁰ are independently selected from the group consisting of hydrogen, linear C1-C10-alkyl, and branched C4-C10-alkyl; 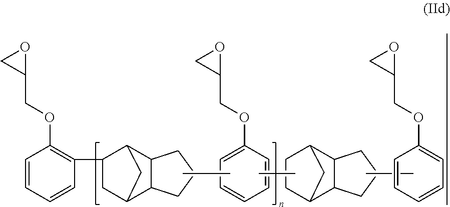
wherein n is 0 or an integer of 1 to 20; and oligomers, prepolymers, polymers or mixtures thereof; 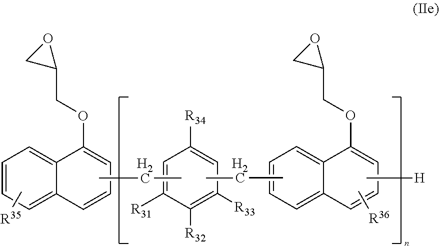
wherein n is an integer of 1 to 20; and R³¹ to R³⁶ are identical or different and independently from each other selected from the group consisting of hydrogen, linear C1-C10-alkyl, branched C3-C10-alkyl, linear C2-C10-alkenyl, and branched C3-C10-alkenyl;
and oligomers, prepolymers, polymers or mixtures thereof; 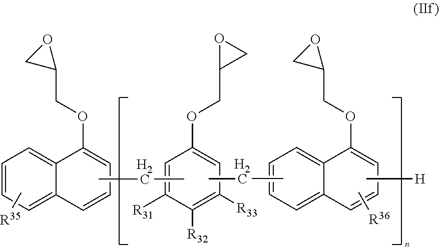
wherein n is an integer of 1 to 20; and R³¹ to R³³, R³⁵, and R³⁶ are identical or different and independently from each other selected from the group consisting of hydrogen, linear C1-C10-alkyl, branched C3-C10-alkyl, linear C2-C10-alkenyl, and branched C3-C10-alkenyl; and oligomers, prepolymers, polymers or mixtures thereof; 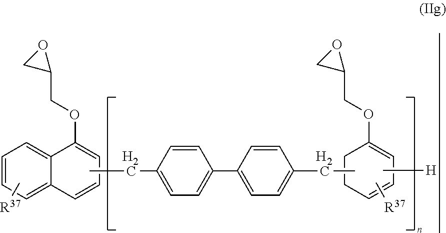
wherein n is an integer of 1 to 20; and R³⁷ is selected from the group consisting of hydrogen, linear C1-C10-alkyl, branched C3-C10-alkyl, linear C2-C10-alkenyl, and branched C3-C10-alkenyl; and oligomers, prepolymers, polymers or mixtures thereof; 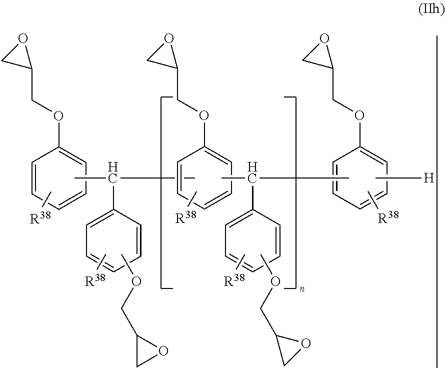
wherein n is 0 or an integer of 1 to 20; and R³⁸ is selected from the group consisting of hydrogen, linear C1-C10-alkyl, branched C3-C10-alkyl, linear C2-C10-alkenyl, and branched C3-C10-alkenyl; and oligomers, prepolymers, polymers or mixtures thereof.

8. The method according to claim 6, wherein the bismaleimide resin is selected from the group consisting of bismaleimide resins of formula (IIIa), bismaleimide resins of formula (IIIb), bismaleimide resins of formula (IIIc), bismaleimide resins of formula (IIId), and substituted bisimide of formula (IIIe) 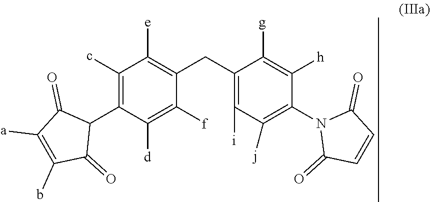
wherein a to j are identical or different and independently from each other selected from the group consisting of hydrogen, halogen, linear C1-C10-alkyl, branched C3-C10-alkyl, linear C2-C10-alkenyl, and branched C3-C10-alkenyl; and oligomers, prepolymers, polymers or mixtures thereof; 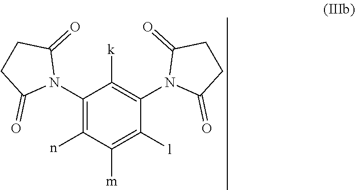
wherein k to m are identical or different and independently from each other selected from the group consisting of hydrogen, halogen, linear C1-C10-alkyl, branched C3-C10-alkyl, linear C2-C10-alkenyl, and branched C3-C10-alkenyl; and oligomers, prepolymers, polymers or mixtures thereof; 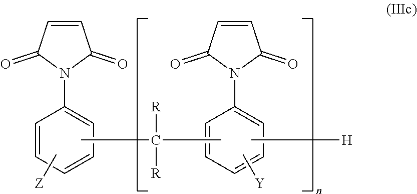
wherein n is an integer of 1 to 20, R, Z, and Y are identical or different and independently from each other selected from the group consisting of hydrogen, halogen, linear C1-C10-alkyl, branched C3-C10-alkyl, linear C2-C10-alkenyl, and branched C3-C10-alkenyl; and oligomers, prepolymers,
polymers or mixtures thereof; 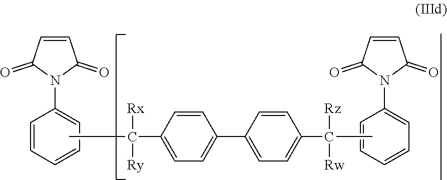
wherein n is an integer of 1 to 20, Rx, Ry, Rz, and Rw are identical or different and independently from each other selected from the group consisting of hydrogen, halogen, linear C1-C10-alkyl, branched C3-C10-alkyl, linear C2-C10-alkenyl, and branched C3-C10-alkenyl; and oligomers, prepolymers, polymers or mixtures thereof; 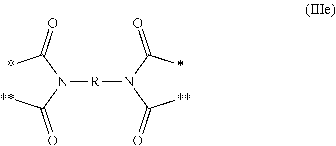
wherein * and ** each denote a covalent bond to the respective C atom denoted with * and ** of a residue,
wherein the residues are identical or different and independently selected from 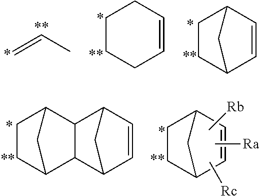
and wherein
R is alkylene, bivalent cycloalkyl, bivalent alkyne, bivalent aryl, bivalent aralkyl, bivalent alkaryl, or bivalent bisaralkyl,
Ra to Rc are independently selected from the group consisting of hydrogen, linear C1-C10-alkyl, linear C1-C10-haloalkyl, branched C4-C10-alkyl, branched C4-C10-haloalkyl, C3-C8-cycloalkyl, halogenated C3-C8-cycloalkyl, linear C2-C10-alkenyl, branched C3-C10-alkenyl, C1-C10-alkoxy, halogen, phenyl and phenoxy,
or Ra and Rb, Ra and Rc, or Rb and Rc may together form a 3 to 8 membered cycloalkyl or a 3 to 8 membered cycloalkenyl; and oligomers, prepolymers, polymers or mixtures thereof.

9. The method according to claim 6, wherein the cyanate ester resin is selected from the group consisting of difunctional cyanate ester compounds of formula (Ia), polyfunctional cyanate esters of formula (Ib), polyfunctional cyanate esters of formula (Ic),
polyfunctional cyanate esters of formula (Id), polyfunctional cyanate esters of formula (Ie), polyfunctional cyanate esters of formula (If), and mixture thereof 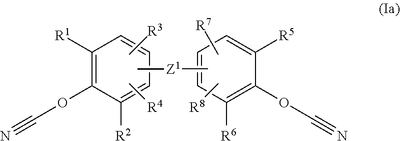
wherein
R¹ through R⁸ are independently selected from the group consisting of hydrogen, linear C1-C10-alkyl, linear C1-C10-haloalkyl, branched C4-C10-alkyl, branched C4-C10-haloalkyl, C3-C8-cycloalkyl, halogenated C3-C8-cycloalkyl, linear C2-C10-alkenyl, branched C3-C10-alkenyl, C1-C10-alkoxy, halogen, phenyl and phenoxy;
wherein at least one of R¹ to R⁸ is selected from the group consisting of linear C2-C10-alkenyl and branched C3-C10-alkenyl;
Z¹ indicates a direct bond or a divalent moiety selected from the group consisting of —O—, —S—, —S(═O)—, —S(═O)₂—, —CH₂—, —CH(CH₃)—, —C(CH₃)₂—, —CH (CF₃)—, —C(CF₃)₂—, —C(═O)—, —C(═CH₂)—, —C(═CCl₂)—, —Si (CH₃)₂—, linear C1-C10-alkanediyl, branched C4-C10-alkanediyl, C3-C8-cycloalkanediyl, 1,2-phenylene, 1,3 phenylene, 1,4 phenylene, —N(R¹³)—wherein R¹³ is selected from the group consisting of hydrogen, linear C1-C10-alkyl, linear C1-C10-haloalkyl, branched C4-C10-alkyl, branched C4-C10-haloalkyl, C3-C8-cycloalkyl, phenyl and phenoxy, and moieties of formulas 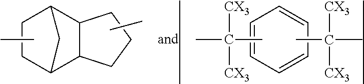
wherein X is independently selected from hydrogen and
halogen; and oligomers, prepolymers, polymers or mixtures thereof; 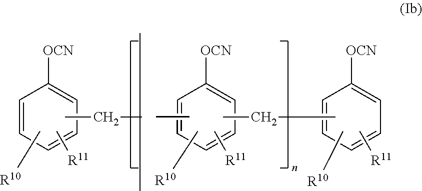
wherein
n is an integer from 1 to 20; and R¹⁰ and R¹¹ are identical or different and independently from each other selected from the group consisting of hydrogen, linear C1-C10-alkyl, branched C4-C10-alkyl, linear C2-C10-alkenyl, and branched C3-C10-alkenyl; and
oligomers, prepolymers, polymers or mixtures thereof; 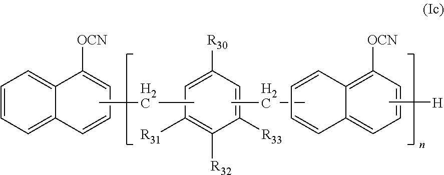
wherein
n is an integer from 1 to 20; and R³⁰, R³¹, R³² and R³³ are identical or different and independently from each other selected from the group consisting of hydrogen, linear C1-C10-alkyl, branched C3-C10-alkyl, linear C2-C10-alkenyl, and branched C3-C10-alkenyl;
and oligomers, prepolymers,
polymers or mixtures thereof; 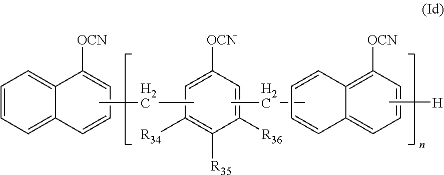
wherein
n is an integer from 1 to 20; and R³⁴, R³⁵ and R³⁶ are identical or different and independently from each other selected from the group consisting of hydrogen, linear C1-C10-alkyl, branched C3-C10-alkyl, linear C2-C10-alkenyl, and branched C3-C10-alkenyl; and oligomers, prepolymers, polymers
or mixtures thereof; 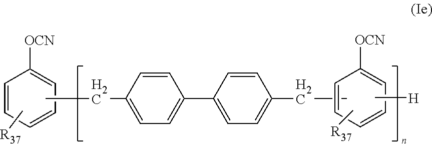
wherein
n is an integer from 1 to 20; and R³⁷ is selected from the group consisting of hydrogen, linear C1-C10-alkyl, branched C3-C10-alkyl, linear C2-C10-alkenyl, and branched C3-C10-alkenyl; andoligomers, prepolymers, polymers or mixtures thereof; 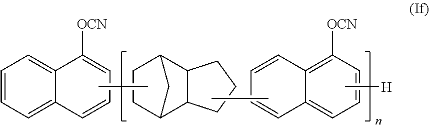
wherein
n is an integer from 1 to 20; and oligomers, prepolymers, polymers or mixtures thereof.

10. The method according to claim 6, wherein the diene resin are selected from the group consisting of butadiene homopolymers, butadiene styrene copolymers, maleinized polybutadienes, and mixtures thereof, preferably wherein the butadiene homopolymers have a formula (IVa), the butadiene styrene copolymers have a formula (IVb), and the maleinized polybutadienes have a formula (IVc) and/or (IVd) 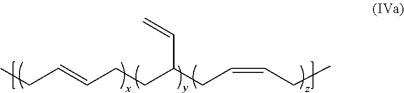
wherein
x, y, and z are identical or different and independently 0 or an integer of 1 to 500, wherein the sum of x+y+z is at least 10; 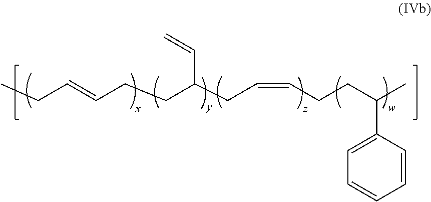
wherein
x, y, z, and w are identical or different and independently 0 or an integer of 1 to 500,
wherein the sum of x+y+z+w is at least 10; 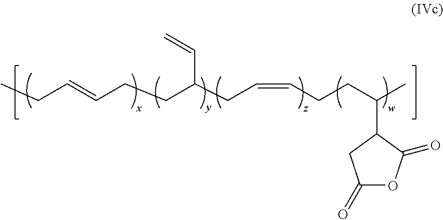
wherein
x, y, z, and ware identical or different and independently 0 or an integer of 1 to 500, wherein the sum of x+y+z+w is at least 10 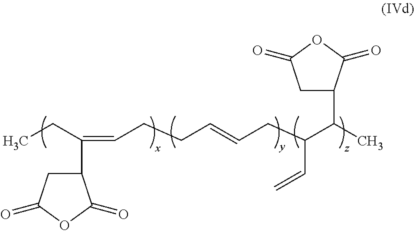
wherein
x, y, z, and w are identical or different and independently 0 or an integer of 1 to 500, wherein the sum of x+y+z+w is at least 10; and/or
wherein the poly(p-phenylene oxide) (PPO) resin is a polyphenylene oxide resin having a structure represented by formula (V): 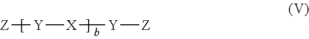
wherein b is a positive integer, X is selected from any one of formula (VI) to formula (VIII) and a combination thereof: 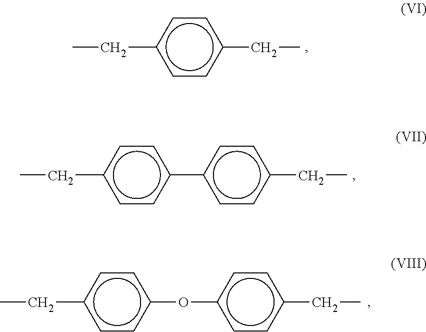
Y has a structure represented by formula (IX): 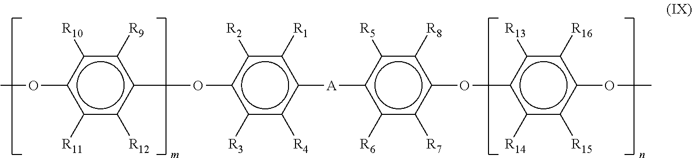
wherein m and n independently represent a positive integer of 1 to 30; R¹ to R¹⁶ are independently selected from H, —CH₃ and halogen atoms; A is selected from a covalent bond, —CH₂—, —CH(CH₃)—, —C(CH₃)₂—, —O—, —S—, —SO₂ and carbonyl group, preferably selected from CH₂—, —CH(CH₃)—, —C(CH₃)₂—, —O—, —S—, —SO₂ and carbonyl group;
and Z has a structure of formula (X), (XI) or (XII) or a combination thereof, preferably has a structure of formula (X) or (XII) or a combination thereof: 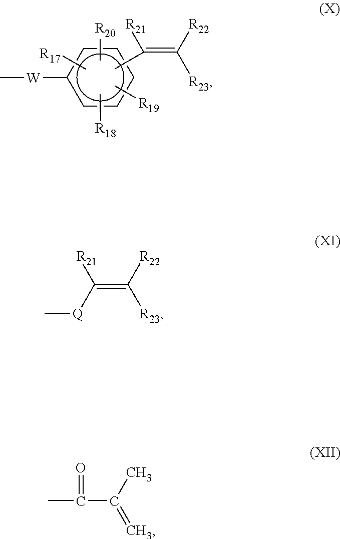
wherein R¹⁷ to R²³ are independently selected from H, —CH₃ and halogen atoms, and Q and W are independently an aliphatic group.

11. The method according to claim 6, wherein the catalyst is selected from the group consisting of radical initiators and Lewis acid catalysts.

12. The method according to claim 1, wherein the the fiber structure provided in step (ii) is selected from the group consisting of carbon fibers, glass fibers, quartz fibers, boron fibers, ceramic fibers, aramid fibers, polyester fibers, polyethylene fibers, natural fibers, and mixtures thereof and/or wherein the fiber structure provided in step (ii) is selected from the group consisting of strands, yarns, rovings, unidirectional fabrics, 0/90° fabrics, woven fabrics, hybrid fabrics, multiaxial fabrics, chopped strand mats, tissues, braids, and combinations thereof.

13. The method according to claim 1, wherein the resin composition (RC) further comprises one or more additional components selected from the group consisting of (internal) mold release agents, fillers, reactive diluents, and mixtures thereof and/or wherein the resin composition (RC) is a liquid mixture.

14. A fiber-reinforced part obtainable by a method according to claim 1.

15. Use of the fiber-reinforced part according to claim 14 in visible or non-visible applications.

16. A visible or non-visible application comprising the fiber-reinforced part according to claim 14.

17. A kit comprising
1) a container (A) comprising
a resin composition (RC) comprising
a) a hydrocarbon resin composition (HRC) derived from a hydrocarbon resin having a structure as defined by formula (A3) 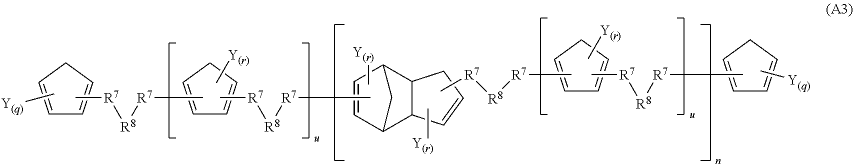
wherein
R⁷ is independently a methylene group (CH₂) or a methylene group substituted with one or more —CH₃ or halogen functionalities;
R⁸ is independently a bond or a straight-chain or branched, linear or cyclic, saturated or unsaturated, substituted or unsubstituted, aliphatic or aromatic group having between 1 and 20 carbon atoms,
Y is independently a functionality possessing at least one non-aromatic alkene, alkyne, C1-C13-alkyl, or an aromatic moiety;
q is an integer of 1 to 5;
r is independently 0 or an integer of 1 to 4,
u is independently 0, or an integer greater than or equal to 1, when u is 0, the bracket region represents a bond, and
n is 0 or an integer greater than or equal to 1, when n is 0, the bracket region represents a bond;
2) optionally a container (B) comprising at least one di- or polyfunctional resin (B); and
3) optionally a container (C);
wherein the kit further comprises a catalyst (C), which is comprised in container (A), container (B), and/or container (C).
